(19) United States
(12) Patent Application Publication
(10) Pub. No.: US 2020/0250166 A1
(43) Pub. Date: Aug. 6, 2020

(54) NATIVE INDEXING FOR A MULTITENANT SCHEMA

(71) Applicant: salesforce.com, inc., San Francisco, CA (US)

(72) Inventor: Rohitashva Mathur, Walnut Creek, CA (US)

(21) Appl. No.: 16/264,442

(22) Filed: Jan. 31, 2019

(51) Int. Cl. G06F 16/22; G06F 16/21

(52) U.S. Cl. CPC G06F 16/2282; G06F 16/212; G06F 16/221

(57) ABSTRACT

A data table comprising one or more table columns including but not limited to an organization table column for identifying individual organizations, data entities and one or more table columns storing common-denominator data type values is accessed. Discriminant values and first native index values are generated by applying discriminant mappings and native index value mappings to table rows in the data table. A function-based table index using the discriminant values and the native index values is generated for the data table. The function-based table index is used for accessing at least a portion of data values in the data table.

### TECHNICAL FIELD

The present invention relates generally to database systems, and in particular, to native indexing for a multitenant schema.

### BACKGROUND

A multitenant (configurable) schema used in a multitenant computing system may allow data tables that interleave data of multiple tenants. Each tenant (or organization) can define or include its own types with data entities such as standard entities and custom entities. Different tenant-specific types may be stored or coalesced in the same data table. Some data tables such as those used to store Accounts, Leads or Contacts each may have data belonging to the same data entity type, whereas other data tables each may have data belonging to many different data entity types such as custom entities or custom defined entity types.

This flexibility of the multitenant schema, while adaptable to diverse data needs of multiple tenants, could come with a significant cost to the multitenant computing system. Multiple native data types (e.g., number, datetime, text, etc.) across different data entities and/or tenants (or organizations) are mapped into the same tables or the same columns therein, thereby limiting the multiple native data types to be converted into a common-denominator data type such as text (e.g., varchar2, etc.). However, different native data orderings of the native data types may be lost in conversion, as databases typically index values of the common-denominator data type such as text differently from how the multiple native data types such as number or datetime should be indexed.

Work-around indexing mechanisms like custom indexes for different organizations and/or different data entities may be implemented via separate tables. However, in order to continuously maintain or debug the work-around indexing mechanism and constructs used therein, substantial costs may be incurred in terms of conceptual weights/intricacies, system resources, query execution costs, corruption tracking/monitoring, human expert resources, and so forth.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF DRAWINGS

The present invention is illustrated by way of example, and not by way of limitation, in the figures of the accompanying drawings and in which like reference numerals refer to similar elements and in which:

FIG. 1A illustrates an example overall function-based indexing framework; FIG. 1B illustrates example data entities as related to multitenant database tables;

FIG. 2 illustrates an example function-based indexing platform;

FIG. 3A illustrates an example multitenant multi-entity database table; FIG. 3B illustrates an example data dictionary; FIG. 3C and FIG. 3F illustrate example custom index metadata; FIG. 3D illustrates an example multitenant single-entity database table; FIG. 3E illustrates an example database table with different data distribution patterns in different data field table columns;

FIG. 4A and FIG. 4B illustrate example process flows; and

FIG. 5 illustrates an example hardware platform on which a computer or a computing device as described herein may be implemented.

### DESCRIPTION OF EXAMPLE EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily occluding, obscuring, or obfuscating the present invention.

Example embodiments are described herein according to the following outline:

1.0. General Overview

2.0. Functional Overview
2.1 Indexing Framework
2.2 Source Database Tables
2.3 Data Dictionaries
2.4 Custom Index Metadata
2.5 Function-Based Indexes
2.6 Type 1 Single-Column Function-Based Indexes
2.7 Type 1 Multi-Column Function-Based Indexes
2.8 Type 2 Function-Based Indexes
2.9 Column Migration

3.0. Example Embodiments

4.0 Implementation Mechanism—Hardware Overview

5.0. Extensions and Alternatives

### 1.0 General Overview

This overview presents a basic description of some aspects of an embodiment of the present invention. It should be noted that this overview is not an extensive or exhaustive summary of aspects of the embodiment. Moreover, it should be noted that this overview is not intended to be understood as identifying any particularly significant aspects or elements of the embodiment, nor as delineating any scope of the embodiment in particular, nor the invention in general. This overview merely presents some concepts that relate to the example embodiment in a condensed and simplified format, and should be understood as merely a conceptual prelude to a more detailed description of example embodiments that follows below.

Hosting organizations in cloud-based systems in private and/or public network clouds can potentially consume a large amount of computing resources, database resources, network resources, human expert resources, etc. Even hosting a single large organization can easily consume some or all available resources of a public cloud host.

Under some approaches, separate custom index tables—which are not native database indexes created with native indexing support of a database system—are created to provide custom indexing support on data entities used to represent or expose organization-specific data respectively to hosted organizations. Building these separate custom index tables and maintaining data consistency between custom index data of the separate custom index tables and the organization-specific data of underlying database tables used to derive the data entities for a large number of organizations can consume very large amounts of computing resources, database resources, network resources, etc.

In addition, when used in read and write database operations (or corresponding data retrieval or storing operations), the separate custom index tables are not as efficient as native database indexes built or maintained with native indexing support of the database system and involve table join operations or other redirection/indirection operations with great costs, as these separate custom index tables may not be naturally taken advantage of by database optimizers as compared with the native database indexes.

In contrast, techniques as described herein can be used to significantly reduce footprints of organizations hosted in a multitenant computing system. Under these techniques, native indexing support as provided by a database system can be (e.g., maximally, readily, etc.) employed to create or build native database indexes such as function-based indexes. The function-based indexes created/built with the native indexing support can be used by database systems natively (e.g., as a part of database operation optimization such as query optimization, etc.) in data retrieval and/or storing operations to access organization-specific data. By directly creating/building the function-based indexes with the native indexing support of the database system, a complex machinery of separate custom index table building and maintenance using application level code outside the native indexing support of the database system is no longer needed and can even be omitted from the multitenant computing system. As a result, lots of bug-prone, performance impacting application level code can be eliminated or much reduced.

As the function-based indexes as described herein are created or built with the native indexing support, the database system automatically maintains the function-based indexes and automatically ensures data consistency and integrity between index values in the function-based indexes and underlying organization-specific data in the underlying database tables on which the function-based indexes are created/built.

For instance, maintaining separate custom index tables under other approaches that do not implement techniques as described herein may rely on triggers, custom Java code, etc., which can be costly in terms of system resources (e.g., the number of writes and/or reads, etc.). When a data field is not unique, an additional separate custom index table may need to be built using or combining with a primary key. Building and maintaining two sets of separate custom index tables in offline or in online operations can greatly increase operational costs and response times for supporting custom indexing under these other approaches.

By way of comparison, since maintaining function-based indexes under techniques as described herein can be done automatically by the database system itself and thus can be both correct and fast, a multitenant computing system or platform can be implemented in a much simpler manner as well as in a more scalable manner. As a result, costs per transaction in a system or platform as described herein may be much reduced.

Using function-based indexes in data retrieval operations or data queries in place of separate custom index tables can result in query response time several times (e.g., three times, etc.) faster than using the separate custom index tables.

Respective custom indexes can still be logically (e.g., without actually creating separate custom index tables outside the native indexing capability of the database system, etc.) defined on respective data entities by any specific organization hosted in the computing system. Information specifying these custom indexes can be stored or cached by the computing system as a part of index metadata. The index metadata may indicate whether a specific custom index is to be created for a specific organization on a specific data field in a specific data entity with a specific native data type such as “string”, “date”, “number”, etc.

Based on the index metadata, function-based indexes—instead of separate custom index tables outside the native indexing capability of the database system—can be created on single data field columns on underlying database tables as well as on multiple data field columns on the underlying database tables.

An example underlying database table may be a multitenant multi-entity database table that comprises data field table column values for a plurality of organizations and for a plurality of data entities (e.g., custom entities or objects, etc.). Another example underlying database table may be a multitenant single-entity database table that comprises data field table column values for a plurality of organizations and for a single data entity type such as a standard entity type (e.g., an account object, etc.).

A single-column function-based index can be created on any single data field table column of an underlying database table storing data field table column values for a plurality of organizations. A multi-column function-based index can be created on any set of multiple data field table columns of an underlying database table storing data field table column values for a plurality of organizations.

Different (single-column or multi-column) function-based indexes—such as case sensitive and insensitive indexes, normalized and unnormalized indexes, unique and non-unique indexes, with or without a primary key column, and so forth—can be created on the same set of data field table column(s) of an underlying database table. The function-based indexes can be generated and maintained—to account for different variations, types, sub-types, etc.—as native indexes of database(s) of database system(s) using native indexing capabilities of the database system(s).

A function-based index as described herein contains function-based index values generated based on an “organization” table column, a “key field” (or “KF”) table column, and one or more data field table columns, of an underlying database table. The “organization” table column stores values for identifying individual organizations. The “KF” table column stores values that can be used along with the values of the “organization” table columns for identifying individual data entities to which rows belong. The data field table columns store values in common-denominator data type such as varchar values, which can be converted to data field values in native data types that are to be represented/exposed in records of corresponding data entities to organizations and/or applications/services thereof.

A data field table column in the underlying database table may store values whose native data types can be different for different organizations (and/or for different data entities). For example, values of the data field table column as stored in a first set of table rows of the underlying database table may be used to derive data field values in a first native data type “string” for a first organization (and/or for a first data entity), whereas values of the data field table column as stored in a second set of table rows of the underlying database table may be used to derive data field values in a second native data type “date” for a second organization (and/or for a second data entity).

Each index value of the function-based index (for a given row) comprises multiple (component) index value fields. The multiple index value fields of each index value of the function-based index comprises an index value field storing a discriminant value generated by a discriminant function. The discriminant function may be specifically selected to generate different discriminant values for different combinations of organization, data entity and indexed data field table column(s). In an embodiment, for the same combination of a specific organization, a specific data entity and a specific set of indexed data field table column(s), the discriminant function returns the same discriminant value. In an embodiment, a discriminant function as described herein and discriminant values generated therefrom also may depend on the index type—case sensitive, case insensitive, unique, non-unique, normalized, non-normalized, one or more ordering criteria (such as whether the comparison is as binary or in a specific language), how many columns over which the index is to be computed or generated, and so forth. As a result, a complete set of index values of the function-based index for the same combination of the specific organization, the specific data entity and the specific set of indexed data field table column(s) can be clustered or identified based on the same discriminant value shared by index values in the complete set of index values of the function-based index. This complete set of index values can be used in place of a separate custom index table to access table rows of the underlying database table or records in the specific data entity that correspond to the table rows of the underlying database table.

The multiple index value fields of each index value of the function-based index (for a given row) comprises an index value field storing a native index value generated by a native index value function for each indexed data field table column. The native index value function may be specifically selected to generate, for each distinct native data type, native index values (in a binary form) that follow the natural order of each such distinct native data type. In various embodiments, the natural order may take into account the type of the index, for example whether the index is case sensitive or not, whether the index is a linguistic index, one or more other factors/variables and so forth.

For example, if a first set of values stored in the indexed data field table column is to be represented or exposed as a native data type “string” in the specific data entity for the specific organization, then the native index value function generates a first set of native index values—from the first set of values stored in the indexed data field table—that follows the natural order (e.g., a lexicographic order, etc.) of the native data type “string”. If a second set of values stored in the indexed data field table column is to be represented or exposed as a native data type “date” in the specific data entity for the specific organization, then the native index value function generates a second set of native index values—from the second set of values stored in the indexed data field table—that follows the natural order (e.g., a datetime order, etc.) of the native data type “date”. If a third set of values stored in the indexed data field table column is to be represented or exposed as a native data type “number” in the specific data entity for the specific organization, then the native index value function generates a third set of native index values—from the third set of values stored in the indexed data field table—that follows the natural order (e.g., a numeric order, etc.) of the native data type “number”.

As used herein, a natural order of a native data type in native index values generated by a native index value function as described herein may be based on an inequality of T1<T2 (e.g., mathematically, etc.) well defined for any two different values of the native data type.

Thus, the natural index values included in the index values of the function-based index can be used to sort, order and/or group records of the specific data entity based on the natural orders of respective natural data types, instead of following the order of the common-denominator data type such as that of varchar.

A discriminant function and a natural index value can be implemented as a stored procedure/function of a database system, a Java function, etc. Any discriminant function can be used so long as discriminant values generated by the discriminant function can distinguish each combination of organization, entity and indexed table column(s). In an example, for each such unique combination, a discriminant function can assign a unique sequence number. In another example, a discriminant function can concatenate respective values of organization, entity and indexed table column(s) with a sufficiently long string. In various embodiments, these and other variations of discriminant functions may be used to generate distinct discriminant values for distinct combinations of organization, entity and indexed table column(s).

The function-based index does not have to return unique index values for all data entities having data stored/persisted in a database table. For example, if there is no custom index specified for a data field in a data entity having data stored/persisted in the database table, then a data field table column of an underlying database table that corresponds to the data field does not have to be indexed in a function-based index of which the data field table column is an indexed table column. A database system can use partial index functionality to return null for table rows from which no function-based index values are to be generated. To eliminate these table rows from the index, a partial index can be created, for example by returning a null value for certain databases. In other embodiments, a database may either specify, or allow to specify, a value that causes a corresponding row not to be indexed. Thus, this partial index value or the null is still returned for the entire key, not just one of value functions or discriminant functions when the database needs the whole key (every component of the index key) to be set to the exclusion value (null in this case).

In some operational scenarios, an underlying database table may comprise a large number of data field table columns. To generate function-based indexes for each of these data field table columns and potentially further combinations of multiple data field table columns, a very large number of function-based indexes would have to be generated. The single function-based index may be created for different organizations from values stored in different data field table columns as specified in column migration metadata that indicates which data field table column for which organization is to be used to create the single function-based index.

Various modifications to the preferred embodiments and the generic principles and features described herein will be readily apparent to those skilled in the art. Thus, the disclosure is not intended to be limited to the embodiments shown, but is to be accorded the widest scope consistent with the principles and features described herein.

### 2.0 Functional Overview

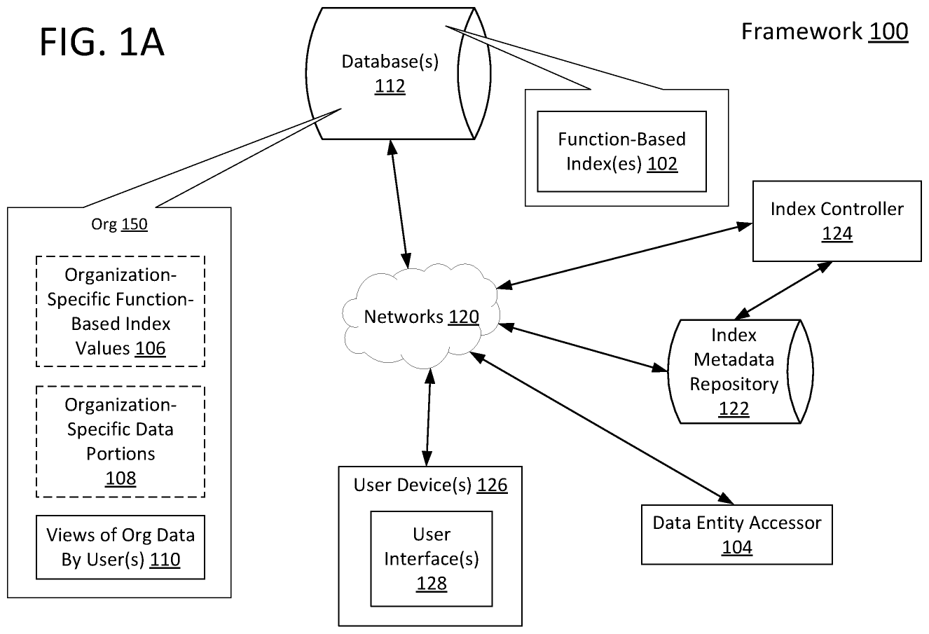

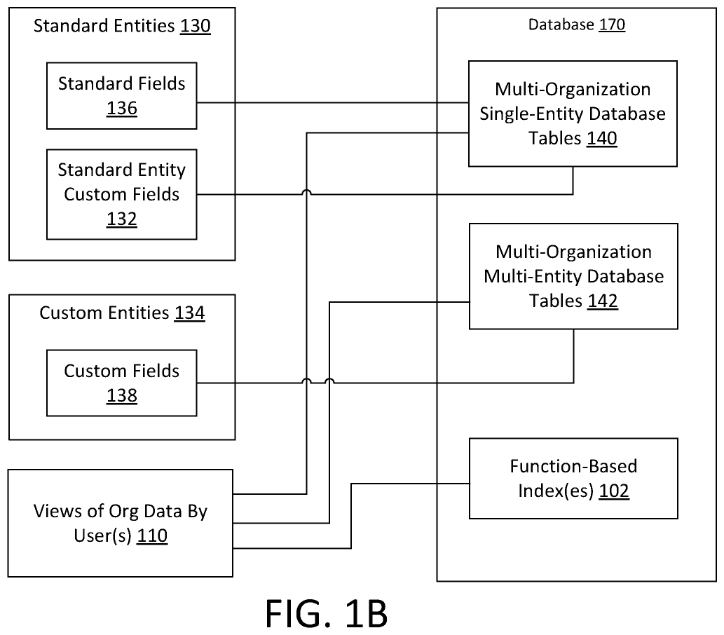

FIG. 1A illustrates an example overall function-based indexing framework 100 in a computing system. Example computing systems that implement the function-based indexing framework (100) may include, but are not necessarily limited to: any of: a large-scale cloud-based computing system, a system with multiple datacenters, multitenant data service systems, web-based systems, systems that support massive volumes of concurrent and/or sequential transactions and interactions, database systems, and so forth. Various system constituents may be implemented through software, hardware, or a combination of software and hardware. Any, some or all of these system constituents may be interconnected and communicated directly, or through one or more networks 120.

A user device (e.g., 126, etc.) may communicate with a computing system through one or more networks 120. A viewing user may interact with data in the computing system using the user device (e.g., 126, etc.) through a user interface (e.g., 128, etc.). For example, a salesperson may access or retrieve data values for potential sales opportunities through the user interface (e.g., 128, etc.). The salesperson may be a user within a specific organization that has thousands of records associated with opportunities. Upon requesting to retrieving data values of opportunity records, a data entity accessor 104 may generate one or more call statements that facilitates access to the data within the opportunity records. The computing system can use organization-specific function-based index values and/or organization-specific data portions accessed at least in part by way of the organization-specific function-based index values to provide quick access to data stored within the computing system at one or more databases 112 of one or more database systems.

As illustrated in FIG. 1A, an organization (“Org”) 150 may provide one or more views of org data by users 110 generated based at least in part on organization-specific function-based index values—or values of the function-based index values that are specific to the organization (150)—in function-based indexes 102 for efficient access to data upon receiving a data fetch request.

At run time, the organization-specific function-based index values in the function-based indexes (102) may be used to access a set of organization-specific data portions—or a data portion set that is specific to the organization (150)—in underlying data tables.

More specifically, the underlying data tables may comprise a plurality of sets of organization-specific data portions across some or all of a plurality of organizations hosted in the computing system. Each set of organization-specific data portions in the plurality of sets of organization-specific data portions of the underlying data tables may be specific to a respective organization in the plurality of organizations hosted in the computing system. For example, the plurality of sets of organization-specific data portions of the function-based indexes (102) may comprise a set of organization-specific data portions 108 for the organization (150).

Likewise, the function-based indexes (102) may comprise a plurality of sets of organization-specific function-based index values across some or all of the plurality of organizations hosted in the computing system. Each set of organization-specific function-based index values in the plurality of sets of organization-specific function-based index values of the function-based indexes (102) may be specific to a respective organization in the plurality of organizations hosted in the computing system. For example, the plurality of sets of organization-specific function-based index values of the function-based indexes (102) may comprise a set of organization-specific function-based index values 106 for the organization (150).

FIG. 1B illustrates example data entities (or data objects) in a (multitenant) computing system as described herein. The data entities include standard entities (or standard objects) 130 that may be standardized for all organizations (or tenants) within the (multitenant) computing system and custom entities (or custom objects) 134 that may be custom defined by respective organizations, while also enabling the organizations to add custom table columns such as standard object custom fields 132 in the standard entities (130) and custom fields 138 in the custom entities (134), other data entities, relationships between or among various data entities (or various data objects), and so forth. Instead of managing a vast, ever-changing set of individual persisted database structures/tables for each application and/or for each organization, the (multitenant) computing system manages a respective set of virtual data structures/tables for each organization based at least in part on metadata, the function-based indexes (102) of FIG. 1A, etc.

For example, when an organization creates new custom entities (or custom objects) as virtual data structures/tables for the organization in a set of virtual data structures/tables for the organization, the computing system generates corresponding new metadata (e.g., in multiple data dictionaries, a single unified data dictionary, a tabular data dictionary, a non-tabular dictionary, a universal data dictionary, a global data dictionary, etc.) defining/specifying the new custom entities, data fields therein, relationships, and other entity/object definition characteristics. Data for all sets of virtual data structures/tables for all organizations can be stored or persisted in a database 170 in a few potentially very large (e.g., underlying, source, persisted, stored, etc.) database tables such as multitenant single-entity database tables 140, multitenant multi-entity database tables 142, and so forth. These underlying database tables can be partitioned in the database (170) by organization and help serve as heap storage.

The computing system may include a database engine that can then materialize virtual data structures/tables or views thereof at runtime for the organization (or for any application implemented/provided to the organization) based on organization-specific metadata, organization-specific data (in the multitenant single-entity database tables (140), the multitenant multi-entity database tables (142), etc.), organization-specific function-based index values (in the function-based indexes (102)), etc., generated for the organization.

The set of virtual data structures/tables for the organization may include the standard entities (130). As illustrated in FIG. 1B, the standard entities (130) may comprise organization-specific data (or portions thereof) for standard (data) fields 136. An example standard entity may include, but is not necessarily limited to only, an account object. The standard fields (136) of the standard entities (130) may be stored in a (e.g., persisted, physically stored, source etc.) multitenant single entity database table (e.g., one of the database tables (140) in the database (170). The custom fields (132) of standard entities (130) may be specified/defined by respective organizations to be included (e.g., logically, virtually, instantiated/built at runtime, etc.) as a part of the standard entities (130). An example of a custom field of a standard entity/object may be, but is not necessarily limited to only, a “Region” custom field of the account object.

The set of virtual data structures/tables for the organization may include the custom entities (134). An example of a custom entity (or custom object) may be an object relating cities to respective zip codes in the U.S. Indexes, pivot tables to enforce unique fields, pivot tables for foreign keys, etc., may also be specified/defined/generated for respective organizations in the (multitenant) computing system.

Separate (e.g., persisted, physically stored, source etc.) database tables in the database (170) may persist or store organization-specific data portions used to derive data values of the standard fields (136) and the custom fields (132) in the standard entities (130). For example, a first organization-specific data portion used to derive some or all data values of the custom fields (132) in the standard entities (130) may be persisted or stored in a (e.g., persisted, physically stored, source etc.) multitenant single-entity database table (e.g., one of 140, etc.) in the database (170). A second organization-specific data portion used to derive some or all data values of the standard fields (136) in the standard entities (130) may be persisted or stored in a (e.g., persisted, physically stored, source etc.) multitenant single-entity database table (e.g., one of 140, etc.) in the database (170). Thus, standard entity custom fields can be stored in a multitenant (or multi-organization) single entity database table. The custom fields can be stored either in the same table in which standard fields are stored, or in a separate table that is specifically for a particular standard entity and has only custom fields for the particular standard entity. Additionally, optionally or alternatively, in some other embodiments, custom fields in a particular standard entity may be stored in a multitenant (or multi-organization) multi-entity database table.

Additionally, optionally or alternatively, a third organization-specific data portion used to derive some or all data values of the custom fields (138) in the custom entities (134) may be persisted or stored in a (e.g., persisted, physically stored, source etc.) multitenant multi-entity database table (e.g., one of 142, etc.) in the database (170). In some embodiments, different data portions in the same multitenant multi-entity database table may be used to populate the custom fields (132) of the standard entities (130) and the custom fields (138) of the custom entities (134). In some other embodiments, separate multitenant multi-entity database tables may be used to populate the custom fields (132) of the standard entities (130) and the custom fields (138) of the custom entities (134).

A data entity such as standard entity or a custom entity may be used to generate or support a particular user's view (e.g., one of 110 of FIG. 1A) to organization-specific data as represented in the data entity. Additionally, optionally or alternatively, two or more data entities such as a combination of standard entities and/or custom entities may be used to generate or support the particular user's view (e.g., one of 110 of FIG. 1A) to organization-specific data as represented in the data entities.

An example user's view (e.g., one of 110 of FIG. 1A, etc.) of the account object (which is a standard entity) may include values of standard fields of the account objects such as “Account Name,” “Employees”, “Industry”, and “Website”. The user's view (e.g., 110 of FIG. 1A, etc.) of the account object may also include values of custom fields of the account objects such as “Region”, “District”, and “Previous Customer.”

The computing system, or a database engine therein, can materialize some or all of the user's views (110) to organization-specific data portions as specified/defined in the standard entities (130) and the custom entities (134) at runtime. Organization-specific function-based index values of the function-based indexes (102) may be used to efficiently access data in the underlying database tables (e.g., 140, 142, etc.) in the database (170) in database read and write operations, to sort or order results of queries as represented in the user's views (110), to organize or group the results of queries as represented in the user's views (110), etc.

2.1 Indexing Framework

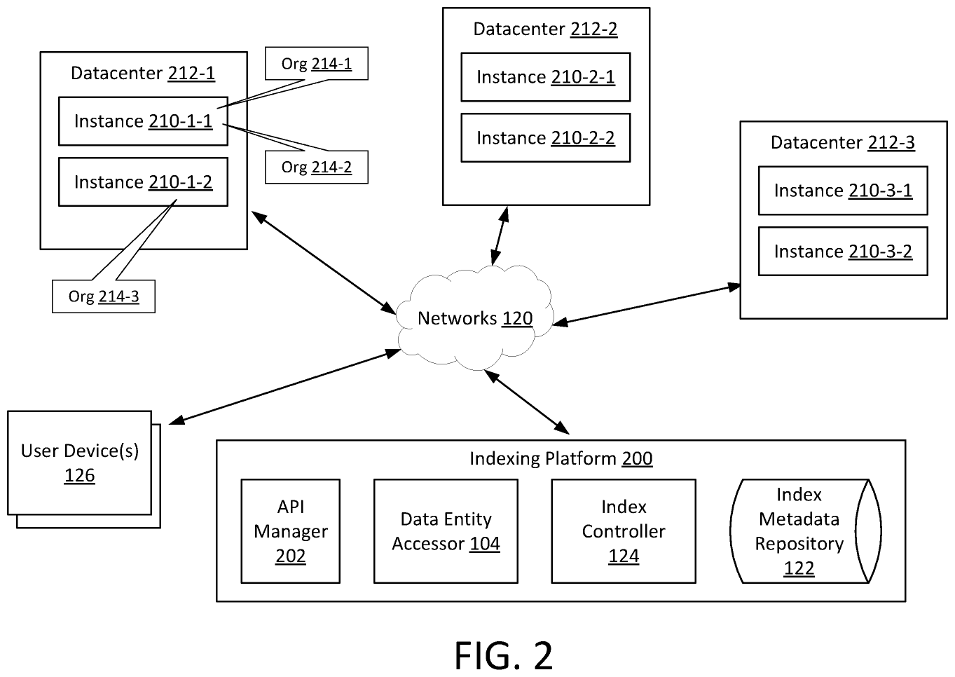

FIG. 2 illustrates an example indexing platform 200 in a computing system. In some embodiments, the computing system that hosts the organizations may comprise a plurality of datacenters such as 212-1, 212-2, 212-3, etc., as illustrated in FIG. 2, which may be located at the same or different geographic locations such as the same or different continents, the same or different countries, the same or different states, the same or different regions, and so forth.

Each data center may implement a set of system instances to host respective organizations. These organizations may contract with the owner of the computing system such as a multitenant computing system to host their respective (e.g., organization-specific, organization-common, etc.) application data, to provide their (e.g., organization-specific, organization-common, etc.) application services to their respective users and/or customers. Examples of application data may include, but are not limited to, organization-specific application data, organization-common application data, application configuration data, application data, application metadata, application code, etc., specifically generated or configured for (e.g., organization-specific, organization-common, etc.) application services of an individual organization, etc.

As used herein, the term “organization” may refer to some or all of (e.g., complete, original, a non-backup version of, a non-cached version of, an online version of, original plus one or more backup or cached copies, an online version plus one or more offline versions of, etc.) application data of an organization hosted in the computer system and application services of the organization based at least in part on the application data.

As illustrated in FIG. 2, each datacenter (e.g., 212-1, 212-2, 212-3, etc.) may comprise a set of one or more system instances. A first datacenter 212-1 comprises first system instances 210-1-1, 210-1-2, etc.; a second datacenter 212-2 comprises second system instances 210-2-1, 210-2-2, etc.; a third datacenter 212-3 comprises third system instances 210-3-1, 210-3-2, etc.

Each system instance (e.g., 210-1-1, 210-1-2, 210-2-1, 210-2-2, 210-3-1, 210-3-2, etc.) in the hosting computing system can host up to a maximum number of organizations such as 5,000 organizations, 10,000 organizations, 15,000+ organizations, etc. As illustrated in FIG. 2, the system instance (210-1-1) in the datacenter (212-1) may host a first organization 214-1 and a second organization 214-2, among others; the system instance (210-1-1) in the datacenter (212-1) may host a third organization 214-3, among others.

In some operational scenarios, read and write database operations based on the separate custom index tables/constructs could incur very high costs (e.g., in terms of computing resources, database resources, response times, etc.), for example three to four times costlier than read and write database operations relying on native function-based indexes provided under techniques as described herein. In addition, building and maintaining the separate custom index tables/constructs can be difficult, burdensome and error prone.

The indexing platform (200) can be used to cause a database system (or a database engine therein) with native function-based indexing capabilities with respect to (e.g., source, etc.) database tables stored or persisted in a database of the database system to generate function-based indexes of the database tables. These function-based indexes may be specifically generated to support deriving, building, instantiating, etc., organization-specific user views (e.g., 110 of FIG. 1A or FIG. 1B, etc.) for some or all organizations hosted in the (multitenant) computing system.

In some embodiments, the function-based indexes can be generated fully automatically with little or no user input (other than respective custom index specifications by users of different organizations) and maintained by the database system using the native indexing capabilities fully automatically. In some embodiments, the function-based indexes can be generated based at least in part on user input.

The indexing platform (200) may include an API manager 202, a data entity accessor 104, an index controller 124, and an index metadata repository 122. The indexing platform 200 can be used to avoid relying on separate custom index tables/constructs (or non-native indexes) to implement custom index functionality on data entities and to use organization-specific function-based index values (e.g., 106 of FIG. 1A or FIG. 1B, etc.) to access organization-specific data represented in the data entities.

2.2 Source Database Tables

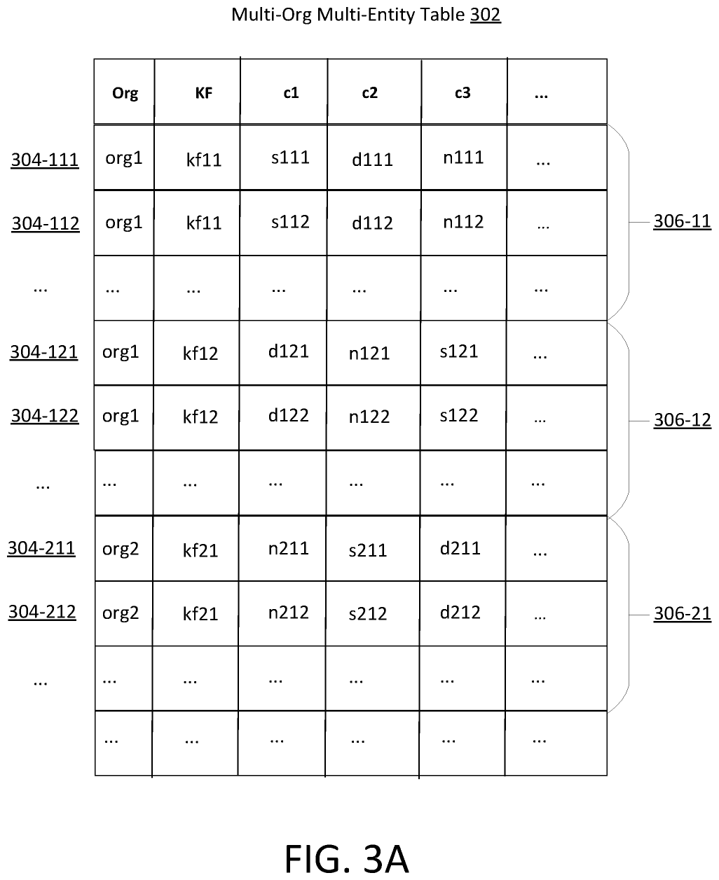

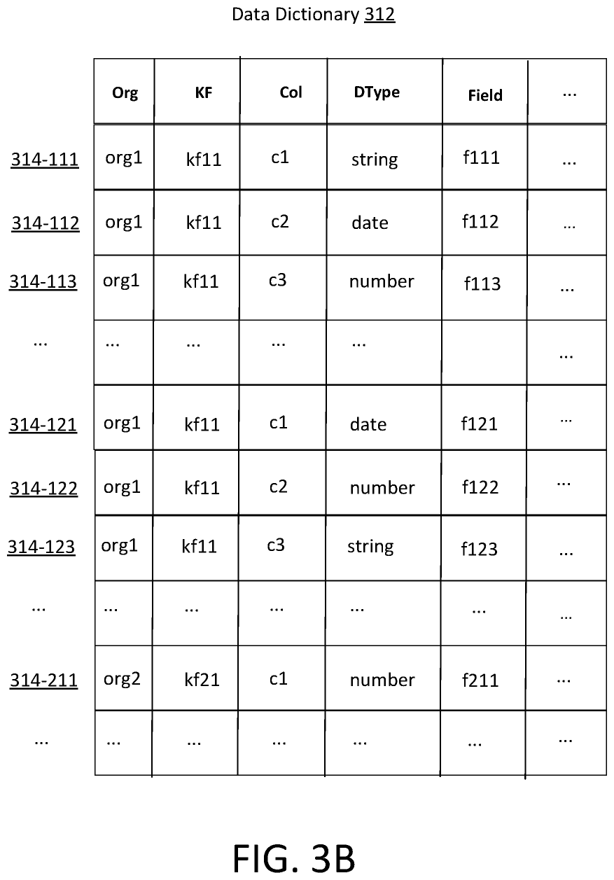

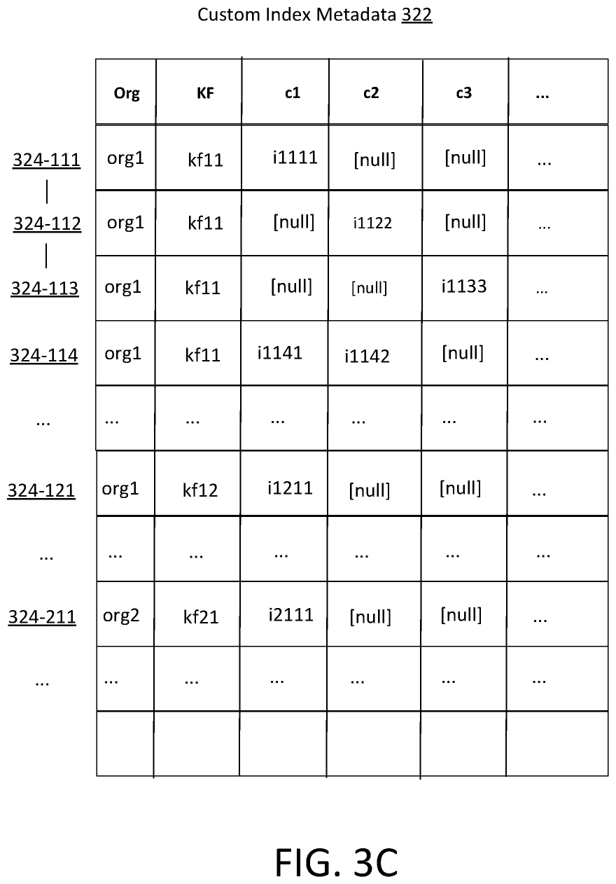

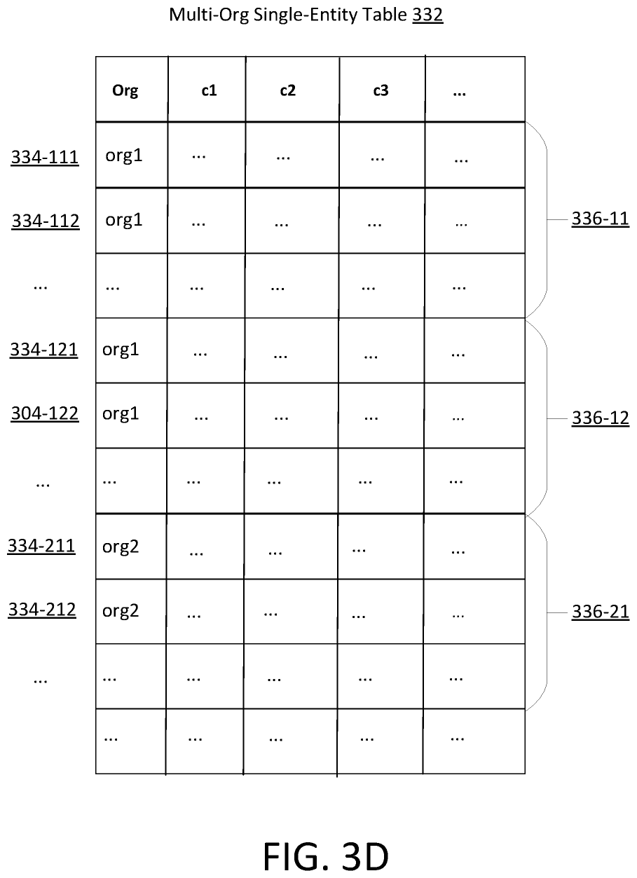

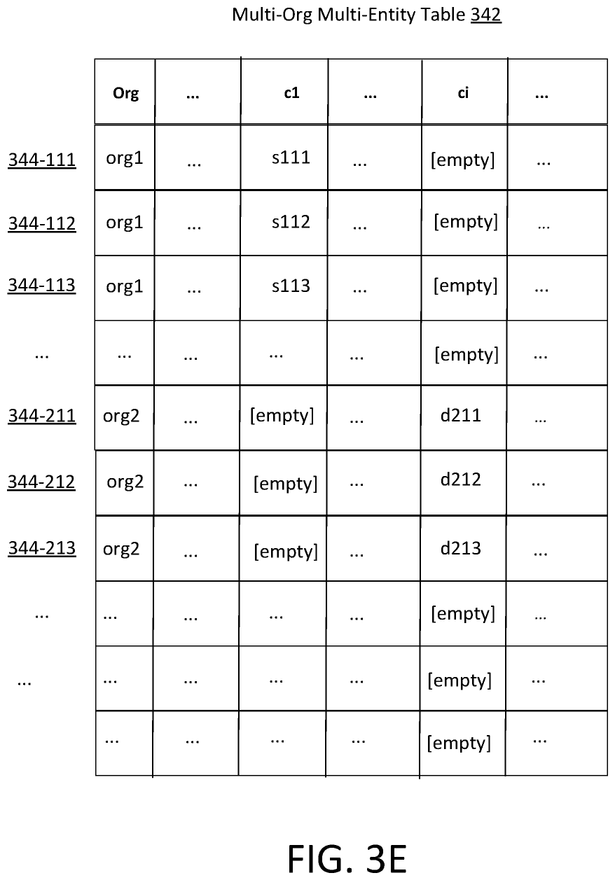

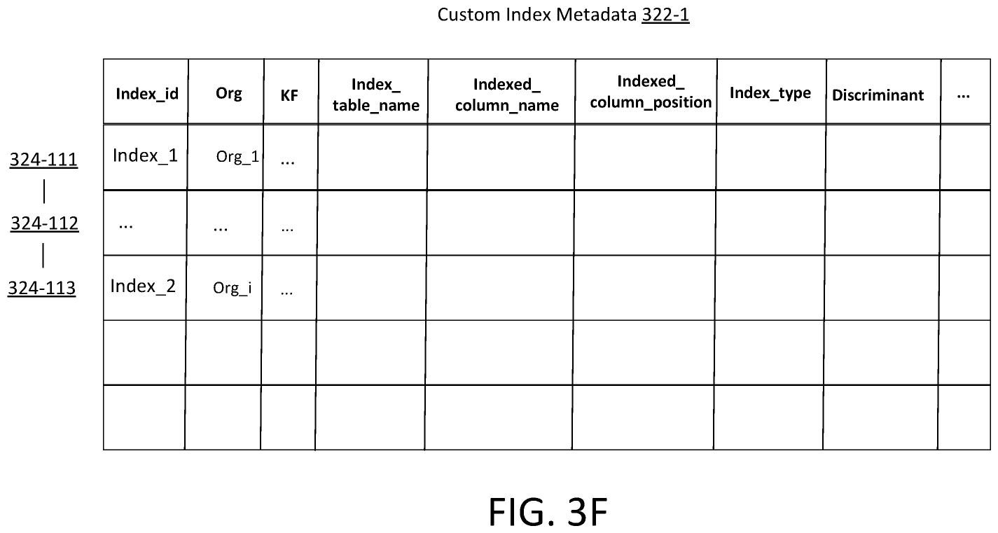

FIG. 3A illustrates an example (e.g., source, underlying, etc.) multitenant multi-entity database table 302 persisted in a database of a database system as described herein. The database table (302) may be used to store and/or persist different organization-specific data portions across a plurality of organizations hosted in a computing system as described herein. Function-based indexes as described herein may be created on the database table (302). Different sets of function-based index values for different organization-specific data portions as stored in the function-based indexes on the database table (302) can be used in place of separate custom index tables under other approaches to access organization-specific data derived from the underlying database table (302).

The different organization-specific data portions in the database table (302) as represented in common-denominator data type(s) can be converted to provide organization-specific data for some or all of individual custom entities (or custom objects), or views thereof, that have been respectively defined and/or specified for the plurality of organizations. The different sets of function-based index values for the different organization-specific data portions of the database table (302) can be used to access the different organization-specific data portions in the database table (302) as represented in common-denominator data type(s).

As illustrated in FIG. 3A, the database table (302) may comprise a plurality of table columns such as “organization” (denoted as “Org”), “key prefix” (denoted as “KF”), “c1”, “c2”, “c3”, and so forth. In some embodiments, for each table row (e.g., 304-111, 304-112, . . . , 304-121, 304-122, . . . , 304-211, 304-212, . . . , etc.) in the database table (302), an “Org” column value (or a value stored in the “Org” column) can be used to determine or identify an organization to which each such table row pertains. The organization may be determined or identified by a look-up operation performed with an organization look-up table (e.g., one of multiple data dictionaries, a single unified data dictionary, a tabular data dictionary, a non-tabular data dictionary, a universal data dictionary, a global data dictionary, etc.) in the computing system using the “Org” column value as a key value.

Additionally, optionally or alternatively, for each table row (e.g., 304-111, 304-112, . . . , 304-121, 304-122, . . . , 304-211, 304-212, . . . , etc.) in the database table (302), an “Org” column value (or a value stored in the “Org” column) and a “KF” column value (or a value stored in the “KF” column) can be used to determine or identify a data entity (e.g., standard entity, custom entity, etc.) based on which data field table column values in each such table row are to be represented to the organization or applications/services thereof. The data entity may be determined or identified by a look-up operation performed with an entity look-up table (e.g., one of multiple data dictionaries, a single unified data dictionary, a tabular data dictionary, a non-tabular dictionary, a universal data dictionary, a global data dictionary, etc.) in the computing system using the “Org” column value and the “KF” column value as key values. In various embodiments, the same look-up table or different look-up tables may be set up for looking up organizations and data entities.

By way of illustration but not limitation, each of the two table rows (304-111 and 304-112) in the database table (302) has the same “Org” column value of “org1” and the same “KF” column value of “kf11”. The “Org” column value of “org1” in the two table rows (304-111 and 304-112) can be used to determine or identify a first organization (“org1”). The “Org” column value of “org1” and the “KF” column value of “kf11” in the two table rows (304-111 and 304-112) can be used to determine or identify a data entity such as a first data entity 306-11 (e.g., “org1_custom_entity_1”, specific to the first organization “org1”, etc.) based on which table column values stored/persisted in the two table rows (304-111 and 304-112) are to be represented to the organization or applications/services thereof.

Similarly, each of the two table rows (304-121 and 304-122) in the database table (302) has the same “Org” column value of “org1” and the same “KF” column value of “kf12”. The “Org” column value of “org1” in the two table rows (304-121 and 304-122) can be used to determine or identify the first organization (“org1”). The “Org” column value of “org1” and the “KF” column value of “kf12” in the two table rows (304-121 and 304-122) can be used to determine or identify a data entity such as a second data entity 306-12 (e.g., “org1_custom_entity_2”, specific to the first organization “org1”, etc.) based on which table column values stored/persisted in the two table rows (304-121 and 304-122) are to be represented to the organization or applications/services thereof.

Similarly, each of the two table rows (304-211 and 304-212) in the database table (302) has the same “Org” column value of “org2” and the same “KF” column value of “kf21”. The “Org” column value of “org2” in the two table rows (304-211 and 304-212) can be used to determine or identify a second organization (“org2”) different from the first organization. The “Org” column value of “org2” and the “KF” column value of “kf21” in the two table rows (304-211 and 304-212) can be used to determine or identify a data entity such as a third data entity 306-21 (e.g., “org2_custom_entity_1”, specific to the first organization “org2”, etc.) based on which table column values stored/persisted in the two table rows (304-211 and 304-212) are to be represented to the organization or applications/services thereof.

As illustrated in FIG. 3A, the plurality of table columns in the database table (302) includes data field table columns such as “c1”, “c2”, “c3”, etc. These data field table (e.g., “c1”, “c2”, “c3”, etc.) columns can be mapped by a data dictionary (e.g., one of multiple data dictionaries, a single unified data dictionary, a tabular data dictionary, a non-tabular dictionary, a universal data dictionary, a global data dictionary, 312 of FIG. 3B, etc.) set up in or by the computer system to different data fields (e.g., “client_address”, “last_update_date”, “total_sales”, etc.) of different data entities (e.g., the first data entity of the first organization “org1”, the second data entity of the first organization “org1”, the third data entity of the second organization “org2”, etc.) for different organizations hosted in the computing system.

2.3 Data Dictionaries

FIG. 3B illustrate an example data dictionary 312 (e.g., one of multiple data dictionaries, a part of a single unified data dictionary, a part of a non-tabular dictionary, a part of a universal data dictionary, a global data dictionary, etc.) represented in a tabular form in the computing system. The data dictionary (312) may comprise a plurality of table columns such as “organization” (denoted as “Org”), “key prefix” (denoted as “KF”), “Col”, “DType”, “Field”, and so forth. For each table row (e.g., 314-111, 314-112, 314-113, . . . , 314-121, 314-122, 314-123, . . . , 314-211, . . . , etc.) in the data dictionary (312) of FIG. 3B, an “Org” column value (or a value stored in the “Org” column) can be used to determine or identify an organization to which each such table row pertains. Additionally, optionally or alternatively, an “Org” column value (or a value stored in the “Org” column) and a “KF” column value (or a value stored in the “KF” column) can be used to determine or identify a data entity based on which data field table column values in each such table row are to be represented to the organization and applications/services thereof.

The table column “Col” of the data dictionary (312) stores data field table column identifiers for data field table columns (e.g., “c1”, “c2”, “c3”, etc.) of the database table (302). Each of the data field table column identifiers of the “Col” table column in a table row of the data dictionary (112), along with a corresponding “Org” table column value and/or a corresponding “KF” table column value in the same table row, can be used to (e.g., uniquely, individually, etc.) identify a corresponding data field table column (e.g., “c1”, “c2”, “c3”, etc.) in the database table (302).

The table column “DType” of the data dictionary (312) stores native data field types of data fields of data entities (e.g., standard entities, custom entities, etc.). The data fields of the data entities are to be populated by data field values of the native data field types. The data field values of the native data field types in the data fields of the data entities are in turn converted from data field table column values of corresponding data field table columns (in the database table (302)) as identified by the data field table column identifiers, respectively. The data field table column values of the corresponding data field table columns persisted/stored in the database table (302) in the database system may be values of common-denominator data type(s).

As used herein, the term “native data field type” may refer to (1) a data type preset/pre-configured by the computing system (e.g., for a standard data field of a standard entity/object, etc.) or (2) a data type specified/defined by a hosted organization (e.g., for a custom data field of a standard entity/object, for a custom data field of a custom entity/object, etc.) based on which data field values are to be represented to the organization and/or applications/services thereof. A native data field type may be deemed as an intended or target data type to be represented by the computing system (or applications/services therein) to an organization or users, customers or application programmers thereof, etc.

Example native data fields as described herein may include, but are not necessarily limited to only, any of: “string”, “date”, “number”, etc. A custom field in a data entity such as a standard entity (or standard object) or a custom entity (or a custom object) of an organization—as exposed/represented by the computing system to the organization—is specified or defined as a native data field type, as illustrated in the data dictionary (312) of FIG. 3B. Some native data field types for custom fields in the data entities (e.g., custom fields 132 in the standard entities 130 of FIG. 1B, custom fields 138 in the custom entities 134 of FIG. 1B, etc.) may be specified by organizations (e.g., an authorized user, a designated user, an application programmer, a support personnel, etc.) that specify/define these custom fields. Some other native data field types for standard fields in the data entities may be preset/pre-configured by the computing system for some or all organizations hosted in the computing system.

In contrast, data field table columns (e.g., “c1”, “c2”, “c3”, etc.) in a (e.g., source, underlying, etc.) database table such as 302 of FIG. 3A may store their values as a common-denominator data type (a single common-denominator data type, one of multiple common-denominator data types, varchar, etc.) such as varchar in the database system.

In data storing operations or other data manipulation operations (DMLs), values of native data field types—in an example as illustrated in 314-111 through 314-113 of FIG. 3B, “string” for “c1”, “date” for “c2”, “number” for “c3” in the first data entity 306-11 of the first organization (“org1”)—in the data entity (the first data entity 306-11 in the present example) are (e.g., forward, etc.) converted into values of corresponding data field table column values (or values in the data field table columns “c1”, “c2”, “c3”, etc., in the present example) in the common-denominator data type such as varchar in the database table (302). The converted values of the corresponding data field table column values (or values in the data field table columns “c1”, “c2”, “c3”, etc., in the present example) in the common-denominator data type such as varchar in the database table (302) can then be persisted and/or stored in the database system.

In data retrieval operations or other data query operations, values of corresponding data field table column values in the common-denominator data type such as varchar in the database table (302) are (e.g., backward, etc.) converted (e.g., instantiated, built, etc.) into values of native data field types in the data entity. The values of the native data field types—as converted from the values of the corresponding data field table column values persisted or stored in the common-denominator data type such as varchar in the database table (302)—can then be exposed/represented to an organization (“org1”) or its users, applications and/or services with or without further manipulation, conversion, etc.

In an example, as illustrated in FIG. 3A and FIG. 3B, values “s111”, “d111”, “n111”, . . . , “s112”, “d112”, “n112”, . . . , etc., of corresponding data field table column values in the data field table columns “c1”, “c2”, “c3”, etc. in the common-denominator data type such as varchar in the table rows 304-111, 304-112, . . . , etc., of the database table (302) are converted into values of native data field types (“string” for “c1”, “date” for “c2”, “number” for “c3”) as illustrated in 314-111 through 314-113 of FIG. 3B in the first data entity (306-11) of the first organization (“org1”). The values of the native data field types in the first data entity (306-11) of the first organization (“org1”) can then be exposed to the first organization (“org1”) or its users, applications and/or services with or without further manipulation, conversion, etc.

In another example, as illustrated in FIG. 3A and FIG. 3B, values “d121”, “n121”, “s121”, . . . , “d122”, “n122”, “s122”, . . . , etc., of corresponding data field table column values in the data field table columns “c1”, “c2”, “c3”, etc. in the common-denominator data type such as varchar in the table rows 304-121, 304-122, . . . , etc., of the database table (302) are converted into values of native data field types (“date” for “c1”, “number” for “c2”, “string” for “c3”) as illustrated in 314-121 through 314-123 of FIG. 3B in the second data entity (306-12) of the first organization (“org1”). The values of the native data field types in the second data entity (306-12) of the first organization (“org1”) can then be exposed to the first organization (“org1”) or its users, applications and/or services with or without further manipulation, conversion, etc.

In yet another example, as illustrated in FIG. 3A and FIG. 3B, values “n211”, “s211”, “d211”, . . . , “n212”, “s212”, “d212”, . . . , etc., of corresponding data field table column values in the data field table columns “c1”, “c2”, “c3”, etc. in the common-denominator data type such as varchar in the table rows 304-211, 304-212, . . . , etc., of the database table (302) are converted into values of native data field types (“number” for “c1”, “string” for “c2”, “date” for “c3”) as illustrated in 314-211 through 314-213 of FIG. 3B in the third data entity (306-21) of the second organization (“org2”). The values of the native data field types in the third data entity (306-21) of the second organization (“org2”) can then be exposed to the second organization (“org2”) or its users, applications and/or services with or without further manipulation, conversion, etc.

The table column “Field” of the data dictionary (312) stores data field names in data entities such as standard entities, custom entities, etc. Field names for data fields such as custom fields in the data entities (e.g., standard entities, custom entities, etc.) may be specified by organizations (e.g., an authorized user, a designated user, an application programmer, a support personnel, etc.) that specify/define these custom fields. Field names for data fields such as standard fields in the data entities may be preset/pre-configured by the computing system for some or all organizations hosted in the computing system.

After values of native data field types are generated from converting values of the corresponding data field table column values in the common-denominator data type such as varchar in the database table (302), these native data field type values can be exposed/represented to an organization or its users, applications and/or services as data field values of corresponding data fields using data field names as illustrated in the data dictionary (312) of FIG. 3B. The organization or its users, applications and/or services can use data field names as illustrated in the data dictionary (312) of FIG. 3B to access the values of the native data field types converted from the values of the corresponding data field table column values in the common-denominator data type such as varchar in the database table (302). Thus, the computing system will perform translations between values of common-denominator data type(s) stored/persisted in the database system and values of native data field types exposed/represented to the organization and/or applications/services thereof.

In an example, as illustrated in 314-111 through 314-113 of FIG. 3B, data field names for data fields in the first data entity (306-11) in the first organization (“org1”) are “f111” (e.g., a more explicit field name as such as “client_address”, corresponding to “c1”, etc.), “f112” (e.g., a more explicit field name as such as “last_update_date”, corresponding to “c2”, etc.), “f113” (e.g., a more explicit field name as such as “total_sales”, corresponding to “c3”, etc.), and the like. In another example, as illustrated in 314-121 through 314-123 of FIG. 3B, data field names for data fields in the second data entity (306-12) in the first organization (“org1”) are “f121” (e.g., corresponding to “c1”, etc.), “f122” (e.g., corresponding to “c2”, etc.), “f123” (e.g., corresponding to “c3”, etc.), etc. In yet another example, as illustrated in 314-211 through 314-213 of FIG. 3B, data field names for data fields in the third data entity (306-21) in the second organization (“org2”) are “f121” (e.g., corresponding to “c1”, etc.), “f122” (e.g., corresponding to “c2”, etc.), “f123” (e.g., corresponding to “c3”, etc.), etc.

2.4 Custom Index Metadata

FIG. 3C and FIG. 3F illustrate example custom index metadata 322 and 322-1 (e.g., a part of a non-tabular metadata, a part of tabular metadata, etc.) represented in a tabular form in the computing system. As illustrated in FIG. 3C, the custom index metadata (322) may comprise a plurality of table columns such as “organization” (denoted as “Org”), “key prefix” (denoted as “KF”), data field table columns “c1”, “c2”, “c3”, and so forth. The plurality of table columns in the custom index metadata (322) corresponds to the plurality of table columns in the database table (302). For example, the data field table columns “c1”, “c2”, “c3”, etc., in the custom index metadata (322) correspond to the same named data field table columns “c1”, “c2”, “c3”, etc., in the database table (302). It should be noted that the tabular format as illustrated in FIG. 3C and other figures are only examples. In various embodiments, other formats other than illustrated in FIG. 3C and other figures can also be used to implement techniques as described herein. For example, in some embodiments, a custom index metadata structure/table may be defined to mirror column names present in the data table. A separate custom index metadata structure/table may be defined for each of the data tables, as there is no reason for column names to be the same for all database tables. As illustrated in FIG. 3F, in some emodiments, instead of the column names as illustrated in FIG. 3C, a custom index metadata structure/table such as 322-1 may comprise the following columns: “Index_id” to identify a particular function-based index, “Org” to identify a particular organization, “KF”, “Indexed_table_name” to identify a corresponding database table to be indexed, “Indexed_column_name” (which may be expanded to a indexed column_name_list in some embodiments) to identify each indexed table column in the corresponding database table, “Indexed_column_position” (which may be expanded to a indexed column_position_list in some embodiments) to identify a position of each indexed table column in the particular function-based index, “Index_type” (which may be expanded to a index_type_list in some embodiments) to identify a type of the index (e.g., component index values generated for a table column, etc.) such as case sensitive, case insensitive, unique, non-unique, normalized, non-normalized, one or more ordering criteria (such as whether the comparison is as binary or in a specific language), how many columns over which the index is to be computed or generated, etc.), “discriminant” to identify a discriminant function, and so forth.

For each table row (e.g., 324-111, 324-112, 324-113, 324-114, . . . , 324-121, . . . , 324-211, . . . , etc.) in the custom index metadata (322), an “Org” column value (or a value stored in the “Org” column) can be used to determine or identify an organization to which each such table row pertains. Additionally, optionally or alternatively, an “Org” column value (or a value stored in the “Org” column) and a “KF” column value (or a value stored in the “KF” column) can be used to determine or identify a data entity on which a custom index is created.

Values in the data field table columns “c1”, “c2”, “c3”, etc., in a table row of the custom index metadata (322) identify one or more data fields of a data entity to be included in a custom index (on the data entity) as determined or identified by the table row (324-111 in the present example) of the custom index metadata (322).

In an example, as illustrated in FIG. 3C, values in the data field table columns “c1”, “c2”, “c3”, etc., in the table row (324-111) of the custom index metadata (322) are “i1111”, [null], [null], . . . , etc. The table row (324-111), or the “Org” value of “org1” and the “KF” value of “kf11” determines or identifies the first data entity in the first organization (“org1”) as a data entity on which a custom index is to be created.

Based on the data dictionary (312), for the first data entity of the first organization (“org1”), the data field table columns “c1”, “c2”, “c3”, etc., in the database table (302) correspond to data fields of field names “f111”, “f112”, “f113”, etc., in the first data entity of the first organization (“org1”). In addition. The data fields of the field names “f111”, “f112”, “f113”, etc., in the first data entity of the first organization (“org1”) have native data field types “string”, “date”, “number”, etc., respectively.

Based on the table row (324-111) in the custom index metadata, the custom index includes data fields of the first data entity of the first organization (“org1”) that correspond to data field columns with non-null values in the data field table columns of the table row (324-111).

Since the only non-null value in the data field table columns of the table row (324-111) is the data field table column “c1”, the custom index as determined or identified by the table row (324-111) is a single-column custom index. The single-column custom index has only a data field (in the first data entity of the first organization “org1”) that corresponds to the data field table column “c1”. This data field in the single-column custom index has the field name “f1111” and the native data field type “string” according to the data dictionary (312).

In another example, as illustrated in FIG. 3C, values in the data field table columns “c1”, “c2”, “c3”, etc., in the table row (324-114) of the custom index metadata (322) are “i1141”, “i1142”, [null], . . . , etc. The table row (324-114), or the “Org” value of “org1” and the “KF” value of “kf11” determines or identifies the first data entity in the first organization (“org1”) as a data entity on which a custom index is to be created.

Based on the table row (324-114) in the custom index metadata, the custom index includes data fields of the first data entity of the first organization (“org1”) that correspond to data field columns with non-null values in the data field table columns of the table row (324-114).

Since the two non-null values in the data field table columns of the table row (324-111) are the data field table columns “c1” and “c2”, the custom index as determined or identified by the table row (324-114) is a two-column custom index. The two-column custom index has two data fields (in the first data entity of the first organization “org1”) that correspond to the data field table columns “c1” and “c2”. The first of the two data fields in the two-column custom index has the field name “f1111” and the native data field type “string”, and the second of the two data fields in the two-column custom index has the field name “f1112” and the native data field type “date”, according to the data dictionary (312).

2.5 Function-Based Indexes

A user such as an operator, an administrator, an authorized user, a designated user, and so forth, of an organization (e.g., 150 of FIG. 1A, any of 214-1 through 214-3, etc.) can use a user device (e.g., 126, etc.) to enter or send a user request (e.g., as a part of a user request for adding one or more custom fields in a data entity, etc.) for creating one or more custom indexes on a data entity that are used to represent organization-specific data derived from underlying database tables to users of the organization.

Additionally, optionally or alternatively, index creation requests may also be issued by an automated process that determines in some way—for example, by analysis of data access and manipulation requests coming in—that creation of such an index would be beneficial for performance/efficiency.

The user request for creating the one or more custom indexes on the data entity can be presented through an application programming interface (API) provided by an API manager (e.g., 202 of FIG. 2, etc.) or another interface provided by an indexing platform (e.g., 200 of FIG. 2, etc.) as described herein. The user device (e.g., 126, etc.) may be operatively linked to, and communicate with, the indexing platform (200) through one or more networks (e.g., 120, etc.) or via a local data connection.

The index controller (124) can generate a custom index metadata portion based on the user request that specifies or defines the one or more custom indexes to be created on the data entity specific to the organization. The custom index metadata portion may specify the one or more custom indexes as a part of a set of custom indexes on a set of data entities specific to the organization.

Based on a plurality of sets of custom indexes as respectively specified for a plurality of organizations hosted in the computing system in the custom index metadata, the indexing controller (124) may identify or determine a set of function-based indexes to support or implement some or all of the plurality of sets of custom indexes. The set of function-based indexes may be generated by the database system offline, on demand, in real time, etc., and may be maintained (e.g., updated, etc.) automatically by the database system at runtime.

In a non-limiting example, some or all indexes in the set of function-based indexed may have been pre-created offline for certain table columns that are likely to be generally heavily indexed across organizations.

Thus, instead of creating or building a set of separate custom index tables outside the native indexing capability of the database system, under techniques as described herein, the set of custom indexes may be (e.g., virtually, etc.) implemented through function-based indexes (e.g., 102 of FIG. 1A or FIG. 1B, etc.) or organization-specific function-based index values in the function-based indexes (102).

At runtime, a user (who may or may not be the same user that specifies custom indexes for an organization) operating a user device (e.g., 126, etc.) may cause the user device to interact with the data entity accessor (104) to access (e.g., create, retrieve, update, delete, a user's view of, etc.) data field values in data entities (e.g., standard entities, custom entities, etc.). This access of the data field values in the data entities may be supported or enabled by one or more applications/services of the organization accessible from the user device. The data entity accessor (104) may invoke a database operation optimizer that (e.g., automatically, with hints provided by the data entity accessor (104), with hints provided by the applications/services of the organization, etc.) make use of organization-specific function-based index values of one or more function-based indexes in the set of function-based indexes. The one or more function-based indexes may comprise index values belonging to (or designated for) multiple organizations of which the organization-specific function-based index values are index values belonging to (or designated for) the organization.

Under techniques as described herein, creating and maintaining the function-based indexes in the computing system can be (e.g., fully, for the most part, etc.) automatically performed using the native indexing capabilities of the database system, thereby causing the organization-specific function-based index values to be (e.g., transparently, without any application servers, without any application level logics, etc.) used for supporting custom indexing capabilities on the data entities in a self-consistent manner at runtime with no or little human intervention (e.g., in normal operational scenarios, etc.).

2.6 Type 1 Single-Column Function-Based Indexes

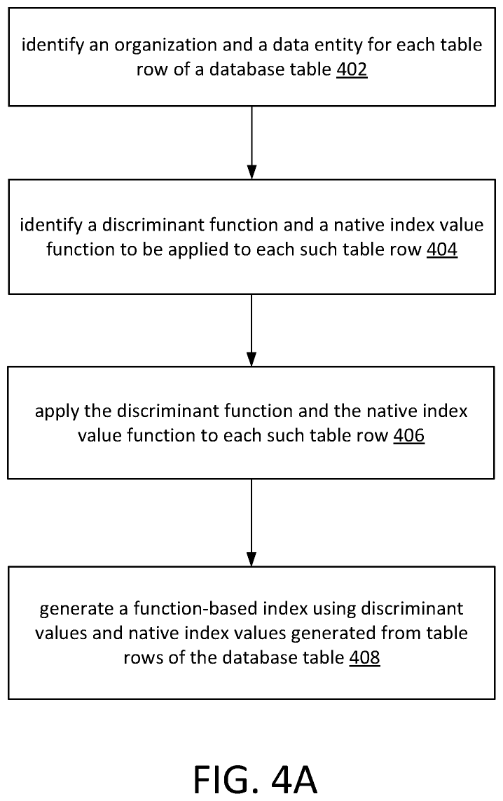

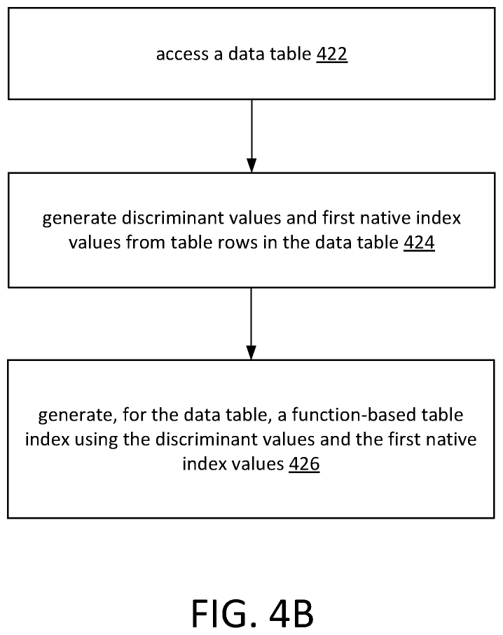

FIG. 4A illustrates an example process flow for generating a (type 1) single-column function-based index on a (type 1) database table. In an embodiment, the process flow may be implemented and/or performed using one or more computer programs, other software elements, and/or digital logic in any of a general-purpose computer or a special-purpose computer, while performing data retrieval, transformation, and storage operations that involve interacting with and transforming the physical state of memory of the computer. The process flow of FIG. 4A illustrates but one example process flow for generating a function-based index. Other process flows may involve additional or fewer steps, in potentially varying arrangements.

As used herein, a type 1 single-column function-based index refers to a function-based index that is created on a type 1 database table, or a multitenant multi-entity database table (e.g., 302 of FIG. 3A, etc.), for a plurality of organizations and for a plurality of data entities, where index values of the type 1 single-column function-based index are made up of function values. For each organization in the plurality of organizations and for each data entity in the plurality of data entities, index values of the type 1 single-column function-based index values are generated based on function values generated by functions (e.g., discriminant and native index value functions/mappings, etc.) using input of (i) values stored/persisted in a single data field table column (e.g., a single data field table column “c1”, etc.) of the multitenant multi-entity database table (302), (ii) values stored/persisted in one or more non-data-field table column (e.g., the table column “Org” and “KF”, etc.) of the multitenant multi-entity database table (302).

A type 1 single-column function-based index as described herein generated for a multitenant multi-entity database table (e.g., 302 of FIG. 3A, etc.) comprises a plurality of sets of function-based index values for a plurality of organizations and for a plurality of data entities.

The plurality of sets of function-based index values in the type 1 single-column function-based index can be used in place of a plurality of corresponding custom indexes for the plurality of organizations and for the plurality of data entities. The plurality of custom indexes for the plurality of organizations and for the plurality of data entities, as supported by the type 1 single-column function-based index, may be specified in custom index metadata (e.g., 322 of FIG. 3C, etc.) for the plurality of organizations.

Each set of function-based index values in the plurality of sets of function-based index values corresponds to, and can be used in place of, a corresponding custom index (in the plurality of custom indexes) for a respective combination of an organization in the plurality of organizations and a data entity in the plurality of data entities. In some operational scenarios, each custom index in the plurality of custom indexes is specified (e.g., in custom index metadata, etc.) to index a data field (e.g., of a data entity of an organization, etc.) that corresponds to the same data field table column (e.g., “c1”, etc.) of a multitenant multi-entity database table (e.g., 302 of FIG. 3A, etc.).

For example, the type 1 single-column function-based index (e.g., created and/or maintained with the native indexing ability of a database system used to persist or store values of the multitenant multi-entity database table (302), etc.) comprises function-based index values specific to each combination of organization and entity in some or all combinations of the plurality of organizations and the plurality of data entities.

Function index values—for a combination of a specific organization and a specific data entity—can be used (e.g., offline, at runtime, etc.) to index table rows (of the multitenant multi-entity database table (302)) from which the function index values are derived. These function index values can be used (e.g., by a data engine automatically, by a database optimizer automatically, etc.)—in place of a separate custom index table created and maintained outside the native indexing ability of a database system used to persist or store values of the multitenant multi-entity database table (302)—to support access organization-specific data field table column values stored in these table rows of the multitenant multi-entity database table (302).

Some or all of these table rows of the multitenant multi-entity database table (302) for the specific organization and the specific data entity are accessed via the function-based indexes in data retrieval or storing operations, values. The specific data entity may comprise records with data fields other than that corresponding to the data field table column indexed by the multi-column function-based index.

Block 402 comprises identifying a corresponding organization (e.g., the first organization “org1”, the second organization “org2”, etc.) and a corresponding data entity (e.g., the first data entity 306-11 of FIG. 3A, the second data entity 306-12 of FIG. 3A, the third data entity 306-21, etc.), for each table row of the multitenant multi-entity database table (302) using values stored/persisted in “Org” and “KF” table columns of each such table row as input; performing a native data field type lookup operation (e.g., a reverse lookup operation, etc.) in a data dictionary (e.g., 312 of FIG. 3B, in multiple data dictionaries, a single unified data dictionary, a tabular data dictionary, a non-tabular dictionary, a universal data dictionary, a global data dictionary, etc.) to determine or identify a native data field type (e.g., “string”, etc.) of the data field table column that corresponds to data fields specified to be indexed by the plurality of custom indexes using values stored/persisted in “Org” and “KF” table columns of each such table row plus the name or identifier (e.g., “c1”, etc.) of the data field table column as input.

Block 404 comprises identifying or determining a type 1 discriminant function (e.g., discriminant mappings, etc.) and a type 1 native index value function (e.g., native index value mappings, etc.) to be applied to each table row of the multitenant multi-entity database table (302).

Block 406 comprises applying the type 1 discriminant function and the type 1 native index value function to each table row of the multitenant multi-entity database table (302). More specifically, a discriminant value is generated by the type 1 discriminant function for each such table row using values stored/persisted in “Org” and “KF” table columns of each such table row plus the name or identifier (e.g., “c1”, etc.) of the data field table column as input. In addition, a native index value function value is generated by the type 1 native index value function for each such table row using values (denoted as “org” and “kf”) stored/persisted in “Org” and “KF” table columns of each such table row plus the name or identifier (e.g., “c1”, denoted as “column”, etc.) of the data field table column as input.

As used herein, a type 1 discriminant function, denoted as D(org, KP, column), where “column” is the name or identifier such as “c1” for a table column to be indexed by the type 1 discriminant function, yields a discriminant value that serves as a unique identifier for each distinct combination (e.g., over several variables/columns such as over a combination of “org”, “KP”, and one or more table columns; over several variables/columns such as “index_id”, “org”, “KF”, “Indexed_table_name”, “Indexed_column_name”, “Indexed_column_position”, “Index_type”, “discriminant”; etc.) of values stored/persisted in “Org” and “KF” table columns of the multitenant multi-entity database table (302) and the name or identifier (e.g., “c1”, etc.) of the data field table column. In some embodiments, a discriminant function may (e.g., implicitly, explicitly, etc.) limit the number of indexes for a unique combination of (org, KP, column) to just one (1). It should be noted that other types or forms of discriminant functions can be used in addition to or in place of the discriminant function D(org, KP, column). That is, in other embodiments, a discriminant function may depend on a different set of arguments or depend on more or fewer arguments than illustrated here. For example, a discriminant function in an example form of D(org, KP, col_id, index_id) may be used in place of the form D(org, KP, col_id) or D(org, KP, column), where “col_id” or “column” serves as an identifier for identifying a table column and “index_id” may be a literal serving as an identifier for identifying a specific index among a plurality of different indexes (e.g., case sensitive, case insensitive, unique, non-unique, normalized, non-normalized, one or more ordering criteria (such as whether the comparison is as binary or in a specific language), how many columns over which the index is to be computed or generated, etc.), “discriminant” to identify a discriminant function, etc.).

Any type 1 discriminant function can be used so long as the type 1 discriminant function generates different values for different combinations of “Org” values, “KF” values, and names/identifiers of data field table columns; for different combinations of “index_id”, “org”, “KF”, “Indexed_table_name”, “Indexed_column_name”, “Indexed_column_position”, “Index_type”, “discriminant”; etc. Thus, the type 1 discriminant function is constrained to generate a first discriminant value for a first type 1 single-column function-based index on a first data field table column of the multitenant multi-entity database table (302) and to generate a second different discriminant value for a second different type 1 single-column function-based index on a second different data field table column of the multitenant multi-entity database table (302), even if “Org” values and “KF” values are the same for both the first type 1 single-column function-based index and the second different type 1 single-column function-based index.

As used herein, a type 1 native index value function, denoted as N(org, KP, column), yields a binary representation of values stored in a data field table column (in the multitenant multi-entity database table (302)) to be indexed by a type 1 single-column function-based index. It should be noted that other types of native index value functions can be used in addition to or in place of the native index function N(org, KP, column). For example, a native index value function in an example form of N(org, KP, col_id, index_id) may be used in place of the form N(org, KP, col_id) or N(org, KP, column), where “col_id” or “column” serves as an identifier for identifying a table column and “index_id” may be a literal serving as an identifier for identifying a specific index among a plurality of different indexes (e.g., case sensitive, case insensitive, unique, non-unique, normalized, non-normalized, one or more ordering criteria (such as whether the comparison is as binary or in a specific language), how many columns over which the index is to be computed or generated, etc.), “discriminant” to identify a discriminant function, etc.). In some embodiments, the value generated by an index function as described herein is used (e.g., only, etc.) if there is actually an index defined on a particular table column. This means that (e.g., in all other cases, etc.) an exclusion value such as a null in the case of Oracle can be return for each of the indexed table columns. If the discriminant function is to return the exclusion value in such cases (e.g., null for oracle, etc.), then the exclusion value is returned, for example for the first column. In some embodiments in which a database allows that an exclusion value is specified on any of the indexed table columns to cause a row not to be indexed can be excluded by the exclusion value as specified with the database. In some other embodiments in which a database does not support this functionality, an actual value returned from invoking an index value function, for example for the 2nd table column can cause rows that should not be indexed to be indexed. In those embodiments, a solution may be implemented to avoid indexing rows for which an index is not defined. In a first example, the index value function may be specified as a part of a conditional expression that returns an exclusion value if the discriminant function returns an exclusion value, returns the value as generated by the index value function otherwise returns. In the case of Oracle, this conditional expression may include a code segment (e.g., a code segment for a stored database procedure, a Java code segment, an APEX code segment, etc.) like “when D( . . . ) is null then null else N( . . . ) end.” In a second example, the index value function “N( . . . )” can take in all the parameters taken by the discriminant function “D( . . . )”, invoke the “D( . . . )” function internally, and return an exclusion value if the “D( . . . )” function results in or returns an exclusion value, otherwise returns the actual index value of the “N( . . . )” function.

The type 1 native index value function is applied to, and generates the native index values from, the values stored in the data field table column to be indexed by the type 1 single-column function-based index.

Any native index value function can be used so long as the native index value function generates, for each distinct combination of an organization and a data entity, different values—of a native data type as specified for the organization and the data entity in a data dictionary (e.g., as illustrated in FIG. 3B, etc.) as described herein—that follow the order of data values for the native data type. Thus, values (e.g., varchar values, etc.) stored in or retrieved from the data field table columns of the multitenant multi-entity database table (302) may or may not follow the same order as the order of data values for the native data type (e.g., “string”, “date”, “number”, etc.). However, the native index values (e.g., a binary type, etc.) generated by the native index value function do follow the order of data values for the native data type.

For the same combination of organization and data entity, different type 1 function-based indexes may be generated, for example when there is more than one index defined on a given table column or field (otherwise it may be stored in the same index structure, with the discriminant function informs or indicates a corresponding index type). For example, a first type 1 native index value function of the different type 1 native index value functions may be case sensitive, whereas a second different type 1 native index value function of the different type 1 native index value functions may be case insensitive. Accordingly, a first type 1 function-based index of the different type 1 function-based indexes may be generated using the first type 1 native index value function, whereas a second different type 1 function-based index of the different type 1 function-based indexes may be generated using the second different type 1 native index value function.

Function-based index metadata may be generated to define or specify using the same index value function declaration to be used with function-based indexes for the same data field table column of the multitenant multi-entity database table (302), thereby allowing the multitenant computing system to create a minimum number of function-based indexes. Additionally, optionally, or alternatively, function-based index metadata may be generated to define or specify which type (e.g., type 1, etc.) and/or which sub-type (e.g., a case sensitive sub-type, a case insensitive sub-type, a normalized sub-type, an unnormalized sub-type, etc.) of native index value function should be used for which function-based index for the same data field table column of the multitenant multi-entity database table (302).

Each unique value generated by the discriminant function serves as a unique (or distinct) identifier for a corresponding unique combination of a specific data field table column, a specific data entity, a specific native data type, and a specific organization, along with other function-based index properties such as case sensitive, case insensitive, unique, non-unique, normalized, non-normalized, one or more ordering criteria (such as whether the comparison is as binary or in a specific language), how many columns over which the index is to be computed or generated, and so forth. Thus, values generated by the discriminant function D(org, kp, column) can be used to logically segment values stored with the data field table column in the multitenant multi-entity database table (302), even though these values stored with the data field table column are all represented in a common-denominator data type such as varchar.

The single-column function-based index orders function-based index values differently for different native data types, for example first ordering the values (e.g., rows, result set, etc.) by their corresponding discriminant values generated by the discriminant function D( . . . ) followed by ordering based on index values if necessary (e.g., when the discriminant values are not unique, etc.). For example, a first subset of values stored in the data field table column to be indexed in the single-column function-based index may correspond to a first native data type such as “string”, whereas a second different subset of values stored in the same data field table column to be indexed in the single-column function-based index may correspond to a second different native data type such as “date”.

The native index value function generates first function-based index values (e.g., “string” values, etc.) from the first subset of values for the first native data type (e.g., “string”, etc.), and generates second different function-based index values (e.g., “date” values, etc.) from the second different subset of values for the second different native data type (e.g., “date”, etc.).

The first function-based index values (e.g., “string” values, etc.) are ordered in the single-column function-based index differently from how the second different function-based index values (e.g., “date” values, etc.) are ordered in the single-column function-based index.

The first function-based index values (e.g., “string” values, etc.) are ordered in the single-column function-based index with the same order as how values of the first native data type are to be natively ordered (e.g., a lexicographic order for “string” values, case sensitive, case insensitive, unique, non-unique, normalized, non-normalized, one or more ordering criteria (such as whether the comparison is as binary or in a specific language), how many columns over which the index is to be computed or generated, etc.), or conform to a native index order of the first native data type.

Likewise, the second different function-based index values (e.g., “date” values, etc.) are ordered in the single-column function-based index with the same order as how values of the second different native data type are to be natively ordered (e.g., a time order for “date” values, etc.), or conform to a native index order of the second native data type.

In some operational scenarios, a subset of values stored in the data field table column to be indexed in the type 1 single-column function-based index may belong to a data entity for which no custom index has been specified for a data field corresponding to the data field table column.

In these operational scenarios, the discriminant function D(org, kp, column) used to generate discriminant values for the type 1 single-column function-based index may return nulls (e.g., there may be a different exclusion value for different databases or different database systems, which may use or designate different null values/forms/indications/markers, etc.) or null values for table rows of the multitenant multi-entity database table (302) that are used to generate data field values in the custom entity. The database system may ignore or avoid indexing these table rows from which nulls or null values are generated by the discriminant function D(org, kp, column), for example using native partial index functionality of the database system. Other table rows of the multitenant multi-entity database table (302) that correspond to other custom entities from which custom indexes are specified can still be indexed with non-null discriminant values in the type 1 single-column function-based index. In some embodiments, the value generated by an index function as described herein is used (e.g., only, etc.) if there is actually an index defined on a particular table column. This means that (e.g., in all other cases, etc.) an exclusion value such as a null in the case of Oracle can be return for each of the indexed table columns. If the discriminant function is to return the exclusion value in such cases (e.g., null for oracle, etc.), then the exclusion value is returned, for example for the first column. In some embodiments in which a database allows that an exclusion value is specified on any of the indexed table columns to cause a row not to be indexed, rows without an index can be excluded by the exclusion value as specified with the database. In some other embodiments in which a database does not support this functionality, an actual value returned from invoking an index value function, for example for the 2nd table column can cause rows that should not be indexed to be indexed. In those embodiments, a solution may be implemented to avoid indexing rows for which an index is not defined. In a first example, the index value function may be specified as a part of a conditional expression that returns an exclusion value if the discriminant function returns an exclusion value, returns the value as generated by the index value function otherwise returns. In the case of Oracle, this conditional expression may include a code segment (e.g., a code segment for a stored database procedure, etc.) like “when D( . . . ) is null then null else N( . . . ) end.” In a second example, the index value function “N( . . . )” can take in all the parameters taken by the discriminant function “D( . . . )”, invoke the “D( . . . )” function internally, and return an exclusion value if the “D( . . . )” function results in or returns an exclusion value, otherwise returns the actual index value of the “N( . . . )” function.

Likewise, in these operational scenarios, the native index value function N(org, kp, column) used to generate native index values for the type 1 single-column function-based index may return nulls or null values for table rows of the multitenant multi-entity database table (302) that are used to generate data field values in the custom entity. The database system may ignore or avoid indexing these table rows from which nulls or null values are generated by the native index value function N(org, kp, column), for example using native partial index functionality of the database system. Other table rows of the multitenant multi-entity database table (302) that correspond to other custom entities from which custom indexes are specified can still be indexed with non-null native index value values in the type 1 single-column function-based index.

Block 408 comprises generating the type 1 single-column function-based index using a plurality of discriminant values generated from applying the discriminant function to a plurality of (e.g., all, etc.) table rows in the multitenant multi-entity database table (302) and a plurality of native index values generated from applying the native index value function to the plurality of table rows in the multitenant multi-entity database table (302).

In some embodiments, each function-based index value (denoted as “type_1_FB_val”) in the type_1 single-column function-based index may be given as follows:

type_1_FB_val=(D(org,kp,column),N(org,kp,column)) (1)

Values stored in the data field table column to be indexed in the type 1 single-column function-based index may or may not be unique. In some embodiments, each function-based index value (denoted as “type_1_FB_val”) in the type 1 single-column function-based index may be given as follows (instead of using index values generated in expression (1) above):

type_1_FB_val=(D(org,kp,column),N(org,kp,column),f(pk,org,kp,column)) (2)

where “pk” denotes a primary key; and f(pk, org, kp, column) represents a function that returns ordered primary key values. The primary key may store (e.g., system-generated) values that are capable of distinguishing each table row in the multitenant multi-entity database table (302), or at least for a unique combination of organization and entity.

In various embodiments, either function-based index values generated with expression (1) above or function-based index values generated with expression (2) above may be used to generate function-based index values in the type 1 single-column function-based index.

Expression (2) above may be used to generate a unique function-based index from a non-unique function-based index by including the primary key values. Conversely, expression (2) above may be used to generate a non-unique function-based index from a unique function-based index by simply letting f(pk, org, kp, column) in expression (2) above return nulls or null values.

As can be seen in expressions (1) and (2), a function-based index value as described herein comprises two or more index value fields. One of these index value fields is given as a discriminant value generated by the discriminant function. All function-based index values for a specific combination (e.g., over several variables/columns such as over a combination of “org”, “KP”, and one or more table columns; over several variables/columns such as “index_id”, “org”, “KF”, “Indexed_table_name”, “Indexed_column_name”, “Indexed_column_position”, “Index_type”, “discriminant”; etc.) of a specific organization and a specific data entity share the same discriminant value generated by the discriminant function and constitute organization-specific function-based index values (e.g., 106 of FIG. 1A, etc.) for the specific data entity of the specific organization (e.g., 150 of FIG. 1A, the first organization “org1”, the second organization “org2”, etc.). Under techniques as described herein, all these function-based index values for the specific combination of the specific organization and the specific data entity can be used to access table rows of the multitenant multi-entity database table (302), instead of a separate custom index table as otherwise would be used under other approaches. As previously noted, a discriminant function or a native index value function may be implemented in a different form other than D(org, KP, column) or N(org, KP, column). For example, a discriminant function or a native index value function may be implemented in a different form such as D(org, KP, col_id) or N(org, KP, col_id). Similarly, a discriminant function or a native index value function may be implemented in a different form such as D(org, KP, index_id) or N(org, KP, index_id). In various embodiments, other forms can also be used. When these other forms are used for discriminant functions and native index value function are used, corresponding expressions similar to those illustrated in expressions (1) and (2) or other expressions (3), (4), and so forth can be used to generate index values as described herein.

Since these function-based index values further comprises index field values generated by the native index value function, and since these index field values generated by the native index value function are ordered depending on the native data type—in the case of native data type “strings”, other factors other than native data type may be included for consideration; these other factors may include, but are not limited to, case sensitive, case insensitive, unique, non-unique, normalized, non-normalized, one or more ordering criteria (such as whether the comparison is as binary or in a specific language), how many columns over which the index is to be computed or generated, etc.—of the data field table column indexed with the function-based index, all these function-based index values for the specific combination of the specific organization and the specific data entity can also be used to sort, order and/or group records (generated from corresponding table rows of the multitenant multi-entity database table (302)) of the specific data entities of the specific organization based on the order of the native data type. Thus, if the data field table column for the specific data entities of the specific organization is a “string” type, the records of the data entity can be ordered or grouped based on a lexicographic order in data retrieval and/or storing operations. Similarly, if the data field table column for the specific data entities of the specific organization is a “date” type, the records of the data entity can be ordered or grouped based on a time order in data retrieval and/or storing operations. And, if the data field table column for the specific data entities of the specific organization is a “number” type, the records of the data entity can be ordered or grouped based on a numeric order in data retrieval and/or storing operations.

2.7 Type 1 Multi-Column Function-Based Indexes

As used herein, a type 1 multi-column function-based index refers to a function-based index that is created on a type 1 database table, or a multitenant multi-entity database table (e.g., 302 of FIG. 3A, etc.), for a plurality of organizations and for a plurality of data entities, where index values of the type 1 multi-column function-based index are made up of function values. For each organization in the plurality of organizations and for each data entity in the plurality of data entities, index values of the type 1 multi-column function-based index values are generated based on function values generated by functions (e.g., discriminant and native index value functions/mappings, etc.) using input of (i) values stored/persisted in multiple data field table columns (e.g., multiple data field table column “c1”, “c2”, etc.) of the multitenant multi-entity database table (302), (ii) values stored/persisted in one or more non-data-field table column (e.g., the table column “Org” and “KF”, etc.) of the multitenant multi-entity database table (302).

A type 1 multi-column function-based index as described herein generated for a multitenant multi-entity database table (e.g., 302 of FIG. 3A, etc.) comprises a plurality of sets of function-based index values for a plurality of organizations and for a plurality of data entities.

The plurality of sets of function-based index values in the type 1 multi-column function-based index can be used in place of a plurality of corresponding custom indexes for the plurality of organizations and for the plurality of data entities. The plurality of custom indexes for the plurality of organizations and for the plurality of data entities, as supported by the type 1 multi-column function-based index, may be specified in custom index metadata (e.g., 322 of FIG. 3C, etc.) for the plurality of organizations.

Each set of function-based index values in the plurality of sets of function-based index values corresponds to, and can be used in place of, a corresponding custom index (in the plurality of custom indexes) for a respective combination of an organization in the plurality of organizations and a data entity in the plurality of data entities. In some operational scenarios, each custom index in the plurality of custom indexes is specified (e.g., in custom index metadata, etc.) to index a set of data fields (e.g., of a data entity of an organization, etc.) that corresponds to the same set of multiple data field table columns (e.g., “c1” and “c2”, etc.) of a multitenant multi-entity database table (e.g., 302 of FIG. 3A, etc.).

For example, the type 1 multi-column function-based index (e.g., created and/or maintained with the native indexing ability of a database system used to persist or store values of the multitenant multi-entity database table (302), etc.) comprises function-based index values specific to each combination of organization and entity in some or all combinations of the plurality of organizations and the plurality of data entities.

Organization-specific index values—for a combination of a specific organization and a specific data entity—can be used (e.g., offline, at runtime, etc.) to index table rows (of the multitenant multi-entity database table (302)) from which the organization-specific index values are derived. These organization-specific index values can be used (e.g., by a data engine automatically, by a database optimizer automatically, etc.)—in place of a separate custom index table created and maintained outside the native indexing ability of a database system used to persist or store values of the multitenant multi-entity database table (302)—to support access organization-specific data field table column values stored in these table rows of the multitenant multi-entity database table (302).

Once some or all of these table rows of the multitenant multi-entity database table (302) for the specific organization and the specific data entity are accessed via the function-based indexes in data retrieval or storing operations, values (e.g., in a native data field type “string” and “date”, etc.) in a data field (e.g., “f111” and “f112”, etc.) of the specific data entity (e.g., the first data entity, etc.) for the specific organization (e.g., the first organization “org1”, etc.) may be generated from or converted into values (in a common-denominator data type such as varchar) in the data field table columns (e.g., “c1” and “c2”, etc.) in the multitenant multi-entity database table (302). The specific data entity may comprise records with data fields other than those corresponding to the data field table columns indexed by the multi-column function-based index.

A process flow similar to the example process flow of FIG. 4A can be used to generate a (type 1) multi-column function-based index on a (type 1) database table with some exceptions as follows.

By way of example but not limitation, to generate a two-column function-based index on a (type 1) database table such as 302 of FIG. 3A, the same process flow (or a similar process flow to that) of FIG. 4A can be used, except that function-based index values may be given using expressions (3) and (4) below, instead of expressions (1) and (2) above.

More specifically, in some embodiments, each function-based index value (denoted as “type_1_FB_val”) in the type 1 two-column function-based index may be given as follows:

type_1_FB_val=(D(org,kp,column_1,column_2),N(org,kp,column_1),N(org,kp,column_2)) (3)

where “column_1” represents a first data field table column of two data field table columns to be indexed by the type 1 two-column function-based index; “column_2” represents a second data field table column of the two data field table columns to be indexed by the type 1 two-column function-based index; D(org, kp, column_1, column_2) represents a discriminant function. Each unique value generated by the discriminant function D(org, kp, column) serves as a unique (or distinct) identifier for a corresponding unique combination of a specific first data field table column of two data field table columns to be indexed by a type 1 two-column function-based index, a specific second data field table column of the two data field table columns to be indexed by the type 1 two-column function-based index, a specific data entity, a specific native data type, and a specific organization.

Values stored in the two data field table columns to be indexed in the type 1 single-column function-based index may or may not be unique. In some embodiments, each function-based index value (denoted as “type_1_FB_val”) in the type 1 two-column function-based index may be given as follows (instead of using index values generated in expression (3) above):

type_1_FB_val=(D(org,kp,column_1,column_2),N(org,kp,column_1),N(org,kp,column_2),f(pk,org,kp,column_1,column_2)) (4)

In various embodiments, either function-based index values generated with expression (3) above or function-based index values generated with expression (4) above may be used to generate function-based index values in the type 1 two-column function-based index.

Expression (4) above may be used to generate a unique function-based index from a non-unique function-based index by including the primary key values. Conversely, expression (4) above may be used to generate a non-unique function-based index from a unique function-based index by simply letting f(pk, org, kp, column) in expression (4) above return nulls or null values.

As can be seen in expressions (3) and (4), a two-column function-based index value as described herein comprises three or more index value fields. One of these index value fields is given as a discriminant value generated by the discriminant function. All function-based index values for a specific combination (e.g., over several variables/columns such as over a combination of “org”, “KP”, and one or more table columns; over several variables/columns such as “index_id”, “org”, “KF”, “Indexed_table_name”, “Indexed_column_name”, “Indexed_column_position”, “Index_type”, “discriminant”; etc.) of a specific organization and a specific data entity share the same discriminant value generated by the discriminant function and constitute organization-specific function-based index values (e.g., 106 of FIG. 1A, etc.) for the specific data entity of the specific organization (e.g., 150 of FIG. 1A, the first organization “org1”, the second organization “org2”, etc.). Under techniques as described herein, all these function-based index values for the specific combination of the specific organization and the specific data entity can be used to access table rows of the multitenant multi-entity database table (302), instead of a separate custom index table as otherwise would be used under other approaches.

Since these function-based index values further comprises index field values generated by the native index value functions, and since these index field values generated by the native index value function are ordered depending on the native data type—in the case of native data type “strings”, other factors other than native data type may be included for consideration; these other factors may include, but are not limited to, case sensitive, case insensitive, unique, non-unique, normalized, non-normalized, one or more ordering criteria (such as whether the comparison is as binary or in a specific language), how many columns over which the index is to be computed or generated, etc.—of the data field table column indexed with the function-based index, all these function-based index values for the specific combination of the specific organization and the specific data entity can also be used to sort, order and/or group records (generated from corresponding table rows of the multitenant multi-entity database table (302)) of the specific data entities of the specific organization based on the order of the native data type. Thus, if an indexed data field table column for the specific data entities of the specific organization is a “string” type, the records of the data entity can be ordered or grouped based on a lexicographic order in data retrieval and/or storing operations. Similarly, if an indexed data field table column for the specific data entities of the specific organization is a “date” type, the records of the data entity can be ordered or grouped based on a time order in data retrieval and/or storing operations. And, if an indexed data field table column for the specific data entities of the specific organization is a “number” type, the records of the data entity can be ordered or grouped based on a numeric order in data retrieval and/or storing operations. When multiple data field table columns are indexed, some or all of the multiple data field table columns can be individually or in combination used to sort, order and/or group records of the data entity in data retrieval and/or storing operations.

2.8 Type 2 Function-Based Indexes

FIG. 3D illustrates an example (e.g., source, underlying, etc.) multitenant single-entity database table 332 persisted in a database of a database system as described herein. The database table (332) may be used to store and/or persist different organization-specific data portions across a plurality of organizations hosted in a computing system as described herein. Function-based indexes as described herein may be created on the database table (332). Different sets of function-based index values for different organization-specific data portions as stored in the function-based indexes on the database table (332) can be used in place of separate custom index tables under other approaches to access organization-specific data derived from the underlying database table (332).

The different organization-specific data portions in the database table (332) as represented in common-denominator data type(s) can be converted to provide organization-specific data for some or all of individual custom entities (or custom objects), or views thereof, that have been respectively defined and/or specified for the plurality of organizations. The different sets of function-based index values for the different organization-specific data portions of the database table (332) can be used to access the different organization-specific data portions in the database table (332) as represented in common-denominator data type(s).

As illustrated in FIG. 3D, the database table (332) may comprise a plurality of table columns such as “organization” (denoted as “Org”), “c1”, “c2”, “c3”, and so forth. In some embodiments, for each table row (e.g., 334-111, 334-112, . . . , 334-121, 334-122, . . . , 334-211, 304-212, . . . , etc.) in the database table (302), an “Org” column value (or a value stored in the “Org” column) can be used to determine or identify an organization to which each such table row pertains. The organization may be determined or identified by a look-up operation performed with an organization look-up table (e.g., one of multiple data dictionaries, a single unified data dictionary, a tabular data dictionary, a non-tabular data dictionary, a universal data dictionary, a global data dictionary, etc.) in the computing system using the “Org” column value as a key value.

The database table (332) may be used to store data field table column values used to generate data field values in a data entity (e.g., a standard entity, an account object, etc.).

By way of illustration but not limitation, each of the two table rows (334-111 and 334-112) in the database table (332) has the same “Org” column value of “org1”, which can be used to determine or identify a data entity (e.g., a standard entity, an account object, etc.) such as a first data entity 336-11 of the first organization (“org1”) based on which table column values stored/persisted in the two table rows (334-111 and 334-112) are to be represented to the organization or applications/services thereof.

Similarly, each of the two table rows (334-121 and 334-122) in the database table (332) has the same “Org” column value of “org1”, which can be used to determine or identify a data entity (e.g., a standard entity, an account object, etc.) such as a second data entity 336-12 of the first organization (“org1”) based on which table column values stored/persisted in the two table rows (334-121 and 334-122) are to be represented to the organization or applications/services thereof.

Similarly, each of the two table rows (334-211 and 334-212) in the database table (332) has the same “Org” column value of “org2”, which can be used to determine or identify a data entity such as a third data entity 336-21 based on which table column values stored/persisted in the two table rows (334-211 and 334-212) are to be represented to the organization or applications/services thereof.

As illustrated in FIG. 3D, the plurality of table columns in the database table (332) includes data field table columns such as “c1”, “c2”, “c3”, etc. These data field table (e.g., “c1”, “c2”, “c3”, etc.) columns can be mapped by a data dictionary (e.g., one of multiple data dictionaries, a single unified data dictionary, a tabular data dictionary, a non-tabular dictionary, a universal data dictionary, a global data dictionary, 312 of FIG. 3B, etc.) set up in or by the computer system to different data fields in a data entity hosted.

As used herein, a type 2 (single-column or multiple-column) function-based index refers to a function-based index that is created on a type 2 database table, or a multitenant single-entity database table (e.g., 332 of FIG. 3D, etc.), for a plurality of organizations, where index values of the type 2 function-based index are made up of function values. For each organization in the plurality of organizations, index values of the type 2 function-based index values are generated based on function values generated by functions (e.g., discriminant and native index value functions/mappings, etc.) using input of (i) values stored/persisted in single or multiple data field table columns (e.g., single or multiple data field table column “c1”, “c2”, etc.) of the multitenant single-entity database table (332), (ii) values stored/persisted in the table column “Org” of the multitenant single-entity database table (332).

A type 2 function-based index as described herein generated for a multitenant single-entity database table (e.g., 332 of FIG. 3D, etc.) comprises a plurality of sets of function-based index values for a plurality of organizations.

The plurality of sets of function-based index values in the type 2 function-based index can be used in place of a plurality of corresponding custom indexes for the plurality of organizations. The plurality of custom indexes for the plurality of organizations, as supported by the type 2 function-based index, may be specified in custom index metadata (e.g., 322 of FIG. 3C, etc.) for the plurality of organizations.

Each set of function-based index values in the plurality of sets of function-based index values corresponds to, and can be used in place of, a corresponding custom index (in the plurality of custom indexes) for a respective organization in the plurality of organizations. In some operational scenarios, each custom index in the plurality of custom indexes is specified (e.g., in custom index metadata, etc.) to index a set of data field(s) (e.g., of a data entity of an organization, etc.) that corresponds to the same set of data field table column(s) of a multitenant single-entity database table (e.g., 332 of FIG. 3D, etc.).

For example, the type 2 function-based index (e.g., created and/or maintained with the native indexing ability of a database system used to persist or store values of the multitenant single-entity database table (332), etc.) comprises function-based index values specific to each organization in the plurality of organizations.

Function index values—for a combination of a specific organization and a specific data entity—can be used (e.g., offline, at runtime, etc.) to index table rows (of the multitenant single-entity database table (332)) from which the function index values are derived. These function index values can be used (e.g., by a data engine automatically, by a database optimizer automatically, etc.)—in place of a separate custom index table created and maintained outside the native indexing ability of a database system used to persist or store values of the multitenant single-entity database table (332)—to support access organization-specific data field table column values stored in these table rows of the multitenant single-entity database table (332).

Some or all of these table rows of the multitenant single-entity database table (332) for the specific organization and the specific data entity are accessed via the function-based indexes in data retrieval or storing operations, values. The data entity may comprise records with data fields other than those corresponding to the data field table columns indexed by the function-based index.

A process flow similar to the example process flow of FIG. 4A can be used to generate a (type 2) function-based index on a (type 2) database table with some exceptions as follows.

For example, to generate a type 2 single-column function-based index, each function-based index value (denoted as “type_2_FB_val”) in the type 2 single-column function-based index may be given as follows:

type_2_FB_val=(D(org,“name”,column),N(org,“name”,column)) (5)

where “name” denotes a name for a data entity type (e.g., a standard entity type such as account, leads, etc.) supported by the multitenant single-entity database table (332). Each unique value generated by the discriminant function D(org, “name”, column) serves as a unique (or distinct) identifier for a corresponding unique combination of a specific data field table column to be indexed by a type 2 single-column function-based index, a specific native data type, and a specific organization.

Additionally, optionally or alternatively, each function-based index value (denoted as “type_2_FB_val”) in the type_2 single-column function-based index may be given as follows (instead of using index values generated in expression (5) above):

type_2_FB_val=(D(org,“name”,column),N(org,“name”,column),f(pk,“name”,kp,column)) (6)

To generate a type 2 multi-column function-based index, each function-based index value (denoted as “type_2_FB_val”) in the type 2 multi-column function-based index may be given as follows:

type_2_FB_val=(D(org,“name”,column_1,column_2),N(org,“name”,column_1),N(org,“name”,column_2)) (7)

Each unique value generated by the discriminant function D(org, “name”, column_1, column_2) serves as a unique (or distinct) identifier for a corresponding unique combination (e.g., over several variables/columns such as over a combination of “org”, “KP”, and one or more table columns; over several variables/columns such as “index_id”, “org”, “KF”, “Indexed_table_name”, “Indexed_column_name”, “Indexed_column_position”, “Index_type”, “discriminant”; etc.) of a specific first data field table column of two data field table columns to be indexed by a type 2 multi-column function-based index, a specific second data field table column of the two data field table columns to be indexed by the type 2 multi-column function-based index, a specific native data type, and a specific organization.

Additionally, optionally or alternatively, each function-based index value (denoted as “type_2_FB_val”) in the type 2 multi-column function-based index may be given as follows (instead of using index values generated in expression (7) above):

type_2_FB_val=(D(org,“name”,column_1,column_2),N(org,“name”,column_1),N(org,“name”,column_2),f(pk,“name”,kp,column_1,column_2)) (8)

As previously noted, a discriminant function or a native index value function may be implemented in a different form other than D(org, KP, column) or N(org, KP, column). For example, a discriminant function or a native index value function may be implemented in a different form such as D(org, KP, col_id) or N(org, KP, col_id). Similarly, a discriminant function or a native index value function may be implemented in a different form such as D(org, KP, index_id) or N(org, KP, index_id). In various embodiments, other forms can also be used. When these other forms are used for discriminant functions and native index value function are used, corresponding expressions similar to those illustrated in expressions (5) through (8) and so forth can be used to generate index values as described herein.

2.9 Column Migration

In some embodiments, an underlying (e.g., source, etc.) database table in a database as described herein may comprise a number of table columns such as a relatively low number of table columns, a table of intermediate number of table columns, a table of relatively high number of table columns, 500 columns, 800 columns, etc. As the underlying data table is used to store data field table column values across data entities in multiple organizations, some table columns in the underlying data table may comprise non-empty data values (e.g., data field column values, etc.) for one or more first data entities but no (or empty) data values (other than non-empty values in “Org” and/or “KF” columns that defines entities) for one or more second different data entities, whereas some other table columns in the same underlying data table may comprise non-empty data values (e.g., data field values, column values, etc.) for the second data entities but empty data values for the first data entities.

FIG. 3E illustrates an example database table 342 that has different data distribution patterns in different data field table columns. The database table (342) may be a multitenant multi-entity database table such as 302 of FIG. 3A or a multitenant single-entity database table such as 332 of FIG. 3D. The database table (342) comprises a plurality of table columns such as non-data-field table columns (e.g., an “Org” table column, etc.), data field table columns (e.g., “c1”, . . . , “ci”, . . . , etc.), and so forth. The database table (342) comprises a plurality of sets of table rows such as a first set of table rows 344-111, 344-112, 344-113, etc., a second set of table rows 344-211, 344-212, 344-213, etc., and so forth. The first set of table rows (344-111, 344-112, 344-113, etc.) may be specific to, used to generate corresponding first data entities of, a first organization “org1”, whereas the second set of table rows (344-211, 344-212, 344-213, etc.) may be specific to, used to generate corresponding second data entities of, a second organization “org2”.

The data field table column “ci” may contain (or may be populated with) very little data. As illustrated in FIG. 3E, for the data field table column “ci”, non-empty data values (e.g., “d211”, “d212”, “d213”, etc.) may only exist in the second set of table rows (344-211, 344-212, 344-213, etc.). On the other hand, cells of the data field table column “c1” in the second set of table rows (344-211, 344-212, 344-213, etc.) in the database table (342) contain empty values.

To minimize the total number of function-based indexes on database tables of a relatively large number of data field table columns across a relatively large number of organizations, an index controller (e.g., 124 of FIG. 1A or FIG. 2, etc.) may identify a migrated-to data field table column with empty cells to which non-empty data values of a migrated-from data field table column are migrated logically (not physically) for function-based index creation/maintenance. For example, in the present example as illustrated in FIG. 3E, the index controller (124) may identify a different data field table column such as the data field table column “c1” with empty cells to which the non-empty data values of the data field table column “ci” are migrated logically (not physically) for function-based index creation/maintenance.

The index controller (124) may perform column migration operations to reduce the total number of function based indexes. For example, in operational scenarios in which a single-column function-based index is to be created using data field table column values stored in the data field table column “c1” in the first set of table rows (344-111, 344-112, 344-113, etc.) to generate function-based index values for a first data entity of the first organization “org1” and using data field table column values stored in the data field table column “ci” in the first set of table rows (344-111, 344-112, 344-113, etc.) to generate function-based index values for a second data entity in the second organization “org2”. In response to determining that a column value combination of (“org2”, “c1”) is not to be indexed, the index controller (124) swaps the two columns physically for only the data portions that have or belong to the table column value “org2” (e.g., for standard entity, multitenant single-entity table, etc.). If key prefixes are involved (e.g., for custom entity, in a multitenant multi-entity table, etc.), then the scope of this swap performed by the index controller (124) is limited to the data portions (e.g., the second data entity, etc.) that have or belong to the table column value “org2”, as is the indexed/non-indexed check. This allows the same index to be used to store index values for data portions that belong to or have previously (“org1”, “c1”) and (“org2”, “ci”) value combinations. The swap operation can be undertaken in any of a variety of ways. In a non-limiting example, a copy of the data portions having (“org2”, “ci”) value combination may be made in table column portions (“org2”, “c1”), if the table columns portions (“org2”, “c1”) was previously empty; otherwise, the table column portions (“org2”, “c1”) can be first moved to another empty slot if possible (else the swap may not be done or may have to be done with a different table column). Once the table column portions (“org2”, “ci”) have been moved to (“org2”, “c1”), column migration metadata can be created or updated by the index controller (124) for the “org2” data entity in which data portions that were previously mapped to a certain field “ci” is now updated to map to “c1” now.

Index metadata including but not limited to custom index metadata, column migration metadata, etc., may be stored or cached locally or remotely in an index metadata repository (e.g., 122 of FIG. 1A or FIG. 2, etc.).

The databases (112) that stores the underlying data tables may be provided by, or a part of, one or more database systems that support native function-based indexing on the underlying data tables. The index controller (124) can generate callable/executable (function-index related database) statements (e.g., “create index” statements, etc.) from the index metadata.

The callable/executable statements as generated based on the index metadata can be provided to a database system or a database engine therein, for example as a part of a multitenant schema and/or stored database procedures, to cause the database system to create and automatically maintain (e.g., delete, update, insert, retrieve index values, etc.) function-based indexes (e.g., 102 of FIG. 1A, etc.) as described herein. In addition, the function-based indexes (102) automatically maintained by the database system can be used (e.g., by application servers operating in conjunction with database servers, etc.) to provide organization-specific function-based index values that can be used in place of separate custom index tables for any, some or all of the organizations hosted in the computing system.

### 3.0 Example Embodiments

FIG. 4B illustrates an example process flow that may be implemented by one or more computing devices such as a computing system as described herein. In block 422, the system accesses a data table that comprises an organization table column storing organization identification values for identifying individual organizations in a plurality of organizations and a first table column storing first common-denominator data type values converted from first native data type values.

In block 424, the system generates a plurality of discriminant values and a plurality of first native index values by applying discriminant mappings and first native index value mappings to a plurality of table rows in the data table.

Each discriminant value in the plurality of discriminant values is generated by applying the discriminant mappings to a respective table row in the plurality of table rows based on (a) an organization identification value in the organization table column of the respective table row, (b) an identifier for a data entity associated with the respective table row, and (c) an identifier for the first table column of the respective table row. A first native index value in the plurality of first native index values is generated by the first native index value mappings for the respective table row in the plurality of table rows based on the organization identification value, the identifier for the data entity, and a first common-denominator data type value in the first table column of the respective table row.

In block 426, the system generates, for the data table, a function-based table index using the plurality of discriminant values generated by the discriminant mappings and the plurality of first native index values generated by the first native index value mappings. The function-based table index is caused to be used for accessing at least a portion of data values in the data table.

In an embodiment, the first native data type values from which the first common-denominator data type values are converted comprise values of a first organization dependent native data type and values of a second different organization dependent native data type; the plurality of first native index values comprises first index values generated from the values of the first organization dependent native data type and second index values generated from the values of the second different organization dependent native data type; the first index values are ordered depending on the first organization dependent native data type; the second index values are ordered depending on the second different organization dependent native data type.

In an embodiment, the data table is persisted in a database of a database system that natively supports function-based indexing; the function-based index for the data table is natively maintained in the database by the database system as a data table index for the data table.

In an embodiment, the first native index value mappings include column data type lookup operations with a global data dictionary to look up a respective native data type of the first table column for each table row in the plurality of table rows persisted in the data table.

In an embodiment, the plurality of discriminant values and the plurality of first native index values are generated by the discriminant mappings and the first native index value mappings in response to determining, based on custom index metadata, that a data table index that includes the first table column of the data table is to be created for the data table.

In an embodiment, the data table further comprises a table column storing table column values used in combination with the organization identification values to identify individual data entities in a plurality of data entities associated with the plurality of table rows in the data table.

In an embodiment, the data table further comprises a second table column storing second common-denominator data type values converted from second native data type values; the system is further configured to perform: applying second native index value mappings to the plurality of table rows in the data table to generate a plurality of second native index values; a second native index value in the plurality of second native index values being generated by the second native index value mappings for the respective table row in the plurality of table rows based on the organization identification value, the identifier for the data entity, and a second common-denominator data type value in the first table column of the respective table row; generating, for the data table, the function-based table index using further the plurality of second native index values generated by the second native index value mappings.

In some embodiments, process flows involving operations, methods, etc., as described herein can be performed through one or more computing devices or units.

In an embodiment, an apparatus comprises a processor and is configured to perform any of these operations, methods, process flows, etc.

In an embodiment, a non-transitory computer readable storage medium, storing software instructions, which when executed by one or more processors cause performance of any of these operations, methods, process flows, etc.

In an embodiment, a computing device comprising one or more processors and one or more storage media storing a set of instructions which, when executed by the one or more processors, cause performance of any of these operations, methods, process flows, etc. Note that, although separate embodiments are discussed herein, any combination of embodiments and/or partial embodiments discussed herein may be combined to form further embodiments.

### 4.0 Implementation Mechanisms—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

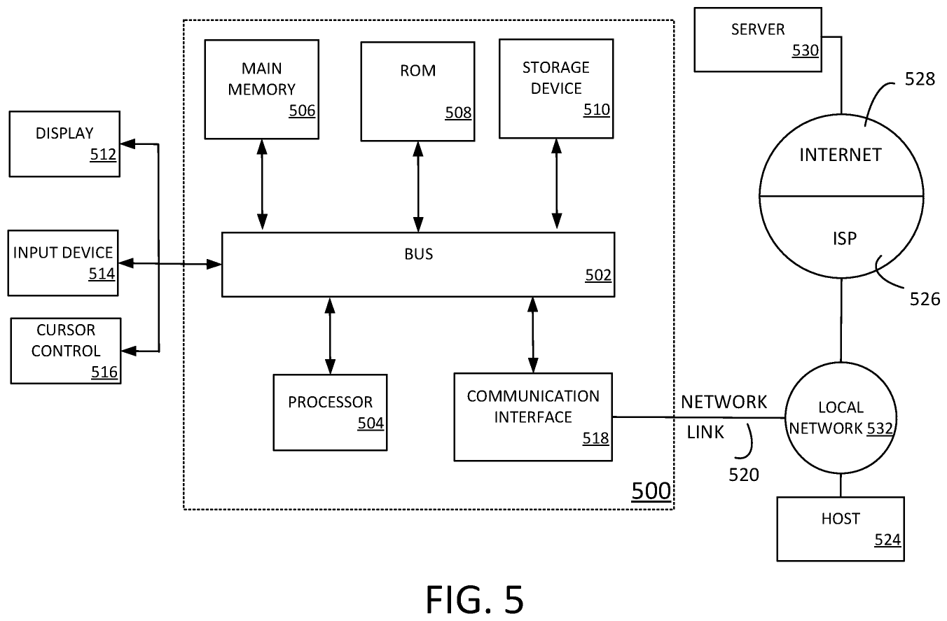

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is device-specific to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a liquid crystal display (LCD), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using device-specific hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 5.0 Equivalents, Extensions, Alternatives and Miscellaneous

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method, comprising:
accessing a data table that comprises an organization table column storing organization identification values for identifying individual organizations in a plurality of organizations and a first table column storing first common-denominator data type values converted from first native data type values;
generating a plurality of discriminant values and a plurality of first native index values by applying discriminant mappings and first native index value mappings to a plurality of table rows in the data table;
each discriminant value in the plurality of discriminant values being generated by applying the discriminant mappings to a respective table row in the plurality of table rows based at least in part on (a) an organization identification value in the organization table column of the respective table row, (b) an identifier for a data entity associated with the respective table row, and (c) an identifier for the first table column of the respective table row; a first native index value in the plurality of first native index values being generated by the first native index value mappings for the respective table row in the plurality of table rows based on the organization identification value, the identifier for the data entity, and a first common-denominator data type value in the first table column of the respective table row;
generating, for the data table, a function-based table index using the plurality of discriminant values generated by the discriminant mappings and the plurality of first native index values generated by the first native index value mappings;
wherein the function-based table index is caused to be used for accessing at least a portion of data values in the data table.

2. The method as recited in claim 1, wherein the first native data type values from which the first common-denominator data type values are converted comprise values of a first organization dependent native data type and values of a second different organization dependent native data type; wherein the plurality of first native index values comprises first index values generated from the values of the first organization dependent native data type and second index values generated from the values of the second different organization dependent native data type; wherein the first index values are ordered depending on the first organization dependent native data type; wherein the second index values are ordered depending on the second different organization dependent native data type.

3. The method as recited in claim 1, wherein the data table is persisted in a database of a database system that natively supports function-based indexing; wherein the function-based index for the data table is natively maintained in the database by the database system as a data table index for the data table.

4. The method as recited in claim 1, wherein the first native index value mappings include column data type lookup operations with a global data dictionary to look up a respective native data type of the first table column for each table row in the plurality of table rows persisted in the data table and a set of index properties, wherein the set of index properties relate to one or more of: a case sensitivity property, a case insensitivity property, a uniqueness property, a non-uniqueness property, a normalization property, a non-normalization property, one or more ordering criteria used to order index values, comparison operations to order character strings as binary or in a specific natural language, a generic property pursuant to a native data type, a linguistic property, a specifical user-defined property, a specific system-defined property, or a list of columns over which the function-based table index is to be generated.

5. The method as recited in claim 1, wherein the plurality of discriminant values and the plurality of first native index values are generated by the discriminant mappings and the first native index value mappings in response to determining, based on custom index metadata, that a data table index that includes the first table column of the data table is to be created for the data table.

6. The method as recited in claim 1, wherein the discriminant mappings are applied to the respective table row in the plurality of table rows further based on one of: (c) an identifier used to uniquely identify a specific type of index value ordering among a plurality of types of index value ordering supported by the discriminant mappings, or (d) an identifier for the first table column of the respective table row.

7. The method as recited in claim 1, wherein the data table further comprises a second table column storing second common-denominator data type values converted from second native data type values; the method further comprising:
applying second native index value mappings to the plurality of table rows in the data table to generate a plurality of second native index values;
generating, for the data table, the function-based table index using further the plurality of second native index values generated by the second native index value mappings.

8. The method as recited in claim 1, wherein the function-based table index is generated, based on organization dependent column migration metadata, to reduce a total number of function-based indexes to be created to accessing original data field values of the original data table.

9. One or more non-transitory computer readable media storing a program of instructions that is executable by a device to perform:
accessing a data table that comprises an organization table column storing organization identification values for identifying individual organizations in a plurality of organizations and a first table column storing first common-denominator data type values converted from first native data type values;
generating a plurality of discriminant values and a plurality of first native index values by applying discriminant mappings and first native index value mappings to a plurality of table rows in the data table;
each discriminant value in the plurality of discriminant values being generated by applying the discriminant mappings to a respective table row in the plurality of table rows based at least in part on (a) an organization identification value in the organization table column of the respective table row, (b) an identifier for a data entity associated with the respective table row, and (c) an identifier for the first table column of the respective table row; a first native index value in the plurality of first native index values being generated by the first native index value mappings for the respective table row in the plurality of table rows based on the organization identification value, the identifier for the data entity, and a first common-denominator data type value in the first table column of the respective table row;
generating, for the data table, a function-based table index using the plurality of discriminant values generated by the discriminant mappings and the plurality of first native index values generated by the first native index value mappings;
wherein the function-based table index is caused to be used for accessing at least a portion of data values in the data table.

10. The media as recited in claim 9, wherein the first native data type values from which the first common-denominator data type values are converted comprise values of a first organization dependent native data type and values of a second different organization dependent native data type; wherein the plurality of first native index values comprises first index values generated from the values of the first organization dependent native data type and second index values generated from the values of the second different organization dependent native data type; wherein the first index values are ordered depending on the first organization dependent native data type; wherein the second index values are ordered depending on the second different organization dependent native data type.

11. The media as recited in claim 9, wherein the data table is persisted in a database of a database system that natively supports function-based indexing; wherein the function-based index for the data table is natively maintained in the database by the database system as a data table index for the data table.

12. The media as recited in claim 9, wherein the first native index value mappings include column data type lookup operations with a global data dictionary to look up a respective native data type of the first table column for each table row in the plurality of table rows persisted in the data table and a set of index properties, wherein the set of index properties relate to one or more of: a case sensitivity property, a case insensitivity property, a uniqueness property, a non-uniqueness property, a normalization property, a non-normalization property, one or more ordering criteria used to order index values, comparison operations to order character strings as binary or in a specific natural language, a generic property pursuant to a native data type, a linguistic property, a specifical user-defined property, a specific system-defined property, or a list of columns over which the function-based table index is to be generated.

13. The media as recited in claim 9, wherein the plurality of discriminant values and the plurality of first native index values are generated by the discriminant mappings and the first native index value mappings in response to determining, based on custom index metadata, that a data table index that includes the first table column of the data table is to be created for the data table.

14. The media as recited in claim 9, wherein the discriminant mappings are applied to the respective table row in the plurality of table rows further based on one of: (c) an identifier used to uniquely identify a specific type of index value ordering among a plurality of types of index value ordering supported by the discriminant mappings, or (d) an identifier for the first table column of the respective table row.

15. The media as recited in claim 9, wherein the data table further comprises a second table column storing second common-denominator data type values converted from second native data type values; the method further comprising:
applying second native index value mappings to the plurality of table rows in the data table to generate a plurality of second native index values;
generating, for the data table, the function-based table index using further the plurality of second native index values generated by the second native index value mappings.

16. The media as recited in claim 9, wherein the function-based table index is generated, based on organization dependent column migration metadata, to reduce a total number of function-based indexes to be created to accessing original data field values of the original data table.

17. A system, comprising:
one or more computing processors;
one or more non-transitory computer readable media storing a program of instructions that is executable by the one or more computing processors to perform:
accessing a data table that comprises an organization table column storing organization identification values for identifying individual organizations in a plurality of organizations and a first table column storing first common-denominator data type values converted from first native data type values;
generating a plurality of discriminant values and a plurality of first native index values by applying discriminant mappings and first native index value mappings to a plurality of table rows in the data table;
each discriminant value in the plurality of discriminant values being generated by applying the discriminant mappings to a respective table row in the plurality of table rows based at least in part on (a) an organization identification value in the organization table column of the respective table row, (b) an identifier for a data entity associated with the respective table row, and (c) an identifier for the first table column of the respective table row; a first native index value in the plurality of first native index values being generated by the first native index value mappings for the respective table row in the plurality of table rows based on the organization identification value, the identifier for the data entity, and a first common-denominator data type value in the first table column of the respective table row;
generating, for the data table, a function-based table index using the plurality of discriminant values generated by the discriminant mappings and the plurality of first native index values generated by the first native index value mappings;
wherein the function-based table index is caused to be used for accessing at least a portion of data values in the data table.

18. The system as recited in claim 17, wherein the first native data type values from which the first common-denominator data type values are converted comprise values of a first organization dependent native data type and values of a second different organization dependent native data type; wherein the plurality of first native index values comprises first index values generated from the values of the first organization dependent native data type and second index values generated from the values of the second different organization dependent native data type; wherein the first index values are ordered depending on the first organization dependent native data type; wherein the second index values are ordered depending on the second different organization dependent native data type.

19. The system as recited in claim 17, wherein the data table is persisted in a database of a database system that natively supports function-based indexing; wherein the function-based index for the data table is natively maintained in the database by the database system as a data table index for the data table.

20. The system as recited in claim 17, wherein the first native index value mappings include column data type lookup operations with a global data dictionary to look up a respective native data type of the first table column for each table row in the plurality of table rows persisted in the data table and a set of index properties, wherein the set of index properties relate to one or more of: a case sensitivity property, a case insensitivity property, a uniqueness property, a non-uniqueness property, a normalization property, a non-normalization property, one or more ordering criteria used to order index values, comparison operations to order character strings as binary or in a specific natural language, a generic property pursuant to a native data type, a linguistic property, a specifical user-defined property, a specific system-defined property, or a list of columns over which the function-based table index is to be generated.

21. The system as recited in claim 17, wherein the plurality of discriminant values and the plurality of first native index values are generated by the discriminant mappings and the first native index value mappings in response to determining, based on custom index metadata, that a data table index that includes the first table column of the data table is to be created for the data table.

22. The system as recited in claim 17, wherein the discriminant mappings are applied to the respective table row in the plurality of table rows further based on one of: (c) an identifier used to uniquely identify a specific type of index value ordering among a plurality of types of index value ordering supported by the discriminant mappings, or (d) an identifier for the first table column of the respective table row.

23. The system as recited in claim 17, wherein the data table further comprises a second table column storing second common-denominator data type values converted from second native data type values; wherein the program of instructions is executable by the one or more computing processors to further perform:
applying second native index value mappings to the plurality of table rows in the data table to generate a plurality of second native index values;
generating, for the data table, the function-based table index using further the plurality of second native index values generated by the second native index value mappings.

24. The system as recited in claim 17, wherein the function-based table index is generated, based on organization dependent column migration metadata, to reduce a total number of function-based indexes to be created to accessing original data field values of the original data table.
